(19) United States
(12) Patent Application Publication
(10) Pub. No.: US 2015/0295291 A1
(43) Pub. Date: Oct. 15, 2015

(54) ELECTRODE BODY FOR BATTERIES, ANODE, AND METAL AIR BATTERY

(71) Applicant: SHARP KABUSHIKI KAISHA, Osaka-shi, Osaka (JP)

(72) Inventors: Shunsuke SATA, Osaka-shi (JP); Akihito YOSHIDA, Osaka-shi (JP); Tomohisa YOSHIE, Osaka-shi (JP); Masaki KAGA, Osaka-shi (JP); Shinobu TAKENAKA, Osaka-shi (JP); Nobuhiko OKA, Osaka-shi (JP); Kazuya SAKASHITA, Osaka-shi (JP); Takahiro MATSUYAMA, Osaka-shi (JP); Hisayuki UTSUMI, Osaka-shi (JP); Yuichi KAMIMURA, Osaka-shi (JP)

(73) Assignee: Sharp Kabushiki Kaisha, Osaka-shi, Osaka (JP)

(21) Appl. No.: 14/436,537

(22) PCT Filed: Oct. 7, 2013
(86) PCT No.: PCT/JP2013/077241

§ 371 Date: Apr. 17, 2015

(30) Foreign Application Priority Data
Oct. 18, 2012 (JP) 2012-231036
Oct. 19, 2012 (JP) 2012-231912

(51) Int. Cl. H01M 12/08

(52) U.S. Cl. CPC H01M 12/08

(57) ABSTRACT

An electrode body for batteries of the invention includes a first metal portion configured to include metal as an electrode active material as a main component, a first structural member configured to cover a part of a surface of the first metal portion, and a coating member configured to cover the other part of the surface of the first metal portion. The first metal portion, the first structural member, and the coating member are provided such that the first metal portion is divided between the first structural member and the coating member or the coating member is separated from the first metal portion to expose the metal included in the first metal portion.

### TECHNICAL FIELD

The present invention relates to an electrode body for batteries, an anode, and a metal air battery.

### BACKGROUND ART

A metal air battery which includes a metal electrode having an electrode active material made of metal as an anode and an air electrode as a cathode has a high energy density, so that it is received a lot of attention as a next-generation battery.

When the metal air battery is used as a secondary battery, dendrites of a branched shape may be generated in the battery from the metal electrode toward the air electrode at the time of charging and become a cause of a short circuit. Therefore, there is proposed a system in which the metal air battery is used as a primary battery and a metal oxide generated as a byproduct is subjected to reduction treatment, so that the electrode active material made of the metal is manufactured and supplied to the metal air battery (for example, see Patent Literature 1).

As the metal air battery used as a primary battery, there is a zinc air battery. FIG. 26 is a schematic cross-sectional view for describing a discharge reaction of the zinc air battery. The zinc air battery is configured such that a zinc electrode 101 including zinc metal as an electrode active material is provided in an alkaline liquid electrolyte 103 as illustrated in FIG. 26, an air electrode 105 is provided on the anion exchange film 106 coming in contact with the liquid electrolyte 103, and outputs power from the zinc electrode 101 and the air electrode 105 by progressing the discharge reaction. Further, as the air electrode 105, an electrode manufactured by carrying an air electrode catalyst in a carbon carrier is generally used.

In the discharge reaction of the zinc air battery, the zinc metal of the zinc electrode 101 reacts with the hydroxide ions in the alkaline liquid electrolyte 103 to be zinc hydroxide and releases electrons into the zinc electrode 101. Thereafter, the zinc hydroxide is dehydrated and zinc oxide is precipitated in the liquid electrolyte. In addition, in the air electrode 105, the hydroxide ions are generated by the reaction between the electrons, water, and oxygen. The hydroxide ions are conducted to the anion exchange film 106 and migrate to the alkaline liquid electrolyte 103. When the discharge reaction is progressed as above, the zinc metal of the zinc electrode 101 is consumed, so that zinc metal as the electrode active material is necessarily supplied to the zinc air battery.

In addition, there is proposed a metal air battery which supplies the electrode active material made of the metal to the metal air battery by inserting a plurality of metal electrodes into a liquid electrolyte tank (for example, see Patent Literature 2).

### CITATION LIST

### Patent Literature

### Patent Literature 1: JP 7-45270 A

### Patent Literature 2: JP 2005-509262 W

### SUMMARY OF INVENTION

### Technical Problem

However, in a conventional system using the metal air battery as the primary battery, the manufactured electrode active material made of metal is necessarily transported up to an installation place of the metal air battery. Therefore, the surface of the electrode active material is oxidized by the air during the transportation, so that an oxide film is formed. When the electrode active material having the oxide film formed in the surface is supplied to the metal air battery to generate the power, a discharge reaction is hindered due to the oxide film, so that the battery performance is degraded. Therefore, the oxide film of the surface is necessarily removed before the electrode active material is supplied into the metal air battery.

The invention has been made in view of the above problem, and an object thereof is to provide an electrode body for batteries which can store or transport the electrode active material while suppressing the oxide film from being formed in the surface of the electrode active material made of metal, and can form an anode including a division surface having no oxide film or an anode including a surface having no oxide film.

### Solution to Problem

The present invention provides an electrode body for batteries including: a first metal portion configured to include metal as an electrode active material as a main component; a first structural member configured to come in contact with a part of a surface of the first metal portion; and a coating member configured to come in contact with the other part of the surface of the first metal portion, wherein the first metal portion, the first structural member, and the coating member are provided such that the first metal portion is divided between the first structural member and the coating member or the coating member is separated from the first metal portion to expose the metal included in the first metal portion.

### Advantageous Effects of Invention

According to the invention, since the electrode body for batteries includes the first metal portion which includes metal as an electrode active material as a main component, an oxide film is not formed in the surface where the electrode reaction is progressed by storing and transporting the electrode body for batteries, so that the electrode active material can be stored and transported.

According to the invention, since the first structural member covering apart of the surface of the first metal portion and the coating member covering the other part of the surface of the first metal portion are provided, when the electrode active material is stored and transported, it is possible to prevent the damage of the electrode active material and the impurity from being mixed into the electrode active material. In addition, it is possible to prevent the oxide film from being formed in the surface of the first metal portion which covers the first structural member and the coating member.

According to the invention, since the first metal portion, the first structural member, and the coating member are provided such that the first metal portion is divided between the first structural member and the coating member or the coating member is separated from the first metal portion to expose the metal included in the first metal portion, it is possible to obtain an electrode having a surface in which the metal as the electrode active material inside the first metal portion or through the surface is exposed. When the obtained electrode is assembled to a main body of a metal air battery as an anode and the power is generated by the metal air battery, an oxide film is not formed in the surface with the metal as the electrode active material exposed, so that an electrode reaction can be smoothly progressed and degradation of a power generation performance can be suppressed. In addition, there is no need to perform a process of removing the oxide film of the electrode surface, and a cost can be reduced.

According to the invention, since the first structural member is provided to be disposed on the first metal portion, the first metal portion can be handled without damage. In addition, it is also possible to collect the power from the first metal portion through the first structural member.

### BRIEF DESCRIPTION OF DRAWINGS

FIG. 1 is a schematic perspective view illustrating a configuration of an electrode body for batteries according to an embodiment of the invention.

FIGS. 2(a) to 2(c) are each schematic cross-sectional views taken along a chain line A-A of FIG. 1.

FIGS. 3(a) to 3(c) are each schematic cross-sectional views of the electrode body for batteries according to an embodiment of the invention.

FIGS. 4(a) to 4(f) are each schematic perspective views of the electrode body for batteries according to an embodiment of the invention.

FIG. 5 is an explanatory diagram of a method of manufacturing an anode of an embodiment of the invention.

FIG. 6 is an explanatory diagram of a method of manufacturing the anode according to an embodiment of the invention.

FIG. 7 is an explanatory diagram of a method of manufacturing the anode according to an embodiment of the invention.

FIG. 8 is an explanatory diagram of a method of manufacturing the anode according to an embodiment of the invention.

FIG. 9 is a schematic cross-sectional view of a metal air battery according to an embodiment of the invention.

FIG. 10 is a schematic perspective view illustrating a configuration of the electrode body for batteries according to an embodiment of the invention.

FIG. 11(a) is a schematic cross-sectional view of the electrode body for batteries taken along the chain line A-A of FIG. 1.

FIG. 11(b) is a schematic cross-sectional view of the anode manufactured from the electrode body for batteries of FIG. 11(a).

FIG. 12(a) is a schematic cross-sectional view of the electrode body for batteries according to an embodiment of the invention.

FIG. 12(b) is a schematic cross-sectional view of the anode manufactured from the electrode body for batteries of FIG. 12(a).

FIG. 13(a) is a schematic cross-sectional view of the electrode body for batteries according to an embodiment of the invention.

FIG. 13(b) is a schematic cross-sectional view of the anode manufactured from the electrode body for batteries of FIG. 13(a).

FIG. 14(a) is a schematic cross-sectional view of the electrode body for batteries according to an embodiment of the invention.

FIG. 14(b) is a schematic cross-sectional view of the anode manufactured from the electrode body for batteries of FIG. 14(a).

FIG. 15(a) is a schematic cross-sectional view of the electrode body for batteries according to an embodiment of the invention.

FIG. 15(b) is a schematic cross-sectional view of the anode manufactured from the electrode body for batteries of FIG. 15(a).

FIG. 16(a) is a schematic cross-sectional view of the electrode body for batteries according to an embodiment of the invention.

FIG. 16(b) is a schematic cross-sectional view of the anode manufactured from the electrode body for batteries of FIG. 16(a).

FIGS. 17(a) to 17(c) are each schematic cross-sectional views of the electrode body for batteries according to an embodiment of the invention.

FIG. 18(a) is a schematic cross-sectional view of the electrode body for batteries according to an embodiment of the invention.

FIG. 18(b) is a schematic cross-sectional view of the anode manufactured from the electrode body for batteries of FIG. 18(a).

FIG. 19(a) is a schematic cross-sectional view of the electrode body for batteries according to an embodiment of the invention.

FIG. 19(b) is a schematic cross-sectional view of the anode manufactured from the electrode body for batteries of FIG. 19(a).

FIG. 20(a) is a schematic cross-sectional view of the electrode body for batteries according to an embodiment of the invention.

FIG. 20(b) is a schematic cross-sectional view of the anode manufactured from the electrode body for batteries of FIG. 20(a).

FIG. 21(a) is a schematic cross-sectional view of the electrode body for batteries according to an embodiment of the invention.

FIG. 21(b) is a schematic cross-sectional view of the anode manufactured from the electrode body for batteries of FIG. 21(a).

FIGS. 22(a) and 22(b) are each schematic cross-sectional views of the electrode body for batteries according to an embodiment of the invention.

FIG. 23(a) is a schematic cross-sectional view of the electrode body for batteries according to an embodiment of the invention.

FIG. 23(b) is a schematic cross-sectional view of the anode manufactured from the electrode body for batteries of FIG. 23(a).

FIGS. 24(a) to 24(f) are each schematic perspective views of the electrode body for batteries according to an embodiment of the invention.

FIG. 25 is a schematic cross-sectional view of a metal air battery according to an embodiment of the invention.

FIG. 26 is a schematic cross-sectional view for describing a discharge reaction of a zinc air battery.

### DESCRIPTION OF EMBODIMENTS

An electrode body for batteries of the invention includes a metal portion which includes metal as an electrode active material as a main component, and first and second structural members (coating members) which cover the surface of the metal portion. The metal portion is provided to be divided into first and second electrode active material portions in order to expose the metal of the metal portion. The first structural member is provided to be disposed on the first electrode active material portion. The second structural member is provided to be disposed on the second electrode active material portion.

According to the invention, since the metal portion is provided to be divided into the first and second electrode active material portions in order to expose the metal therein, it is possible to obtain the first and second electrode active material portions in which the metal of the division surfaces is exposed. When the obtained first and second electrode active material portions are assembled to a main body of a metal air battery as an anode and the power is generated by the metal air battery, an electrode reaction can be smoothly progressed and a power generation performance can be suppressed from being degraded since an oxide film is not formed in the division surfaces of the first and second electrode active material portions. In addition, there is no need to perform a process of removing the oxide film of the electrode active material portion, and a cost can be reduced.

According to the invention, since the first structural member is provided to be disposed on the first electrode active material portion, the first electrode active material portion obtained by dividing the metal portion can be handled without damage. In addition, the power can also be collected from the first electrode active material portion through the first structural member.

According to the invention, since the second structural member is provided to be disposed on the second electrode active material portion, the second electrode active material portion obtained by dividing the metal portion can be handled without damage. In addition, the power can also be collected from the second electrode active material portion through the second structural member.

In the invention, the electrode body for batteries includes metal which is the electrode active material of the battery, and mainly formed when the electrode active material is transported or stored.

In the electrode body for batteries of the invention, it is desirable that the first and second structural members be substantially formed to cover the entire surface of the metal portion. In addition, it is desirable that the first and second structural members be formed to be in contact or close contact with the metal portion in the entire surface facing the surface of the metal portion. Furthermore, it is desirable that the end portion of the first structural member and the end portion of the second structural member come in contact or close contact with each other and the metal portion be provided to be divided in the surface including the contact or close contact portion.

With such a configuration, when the electrode active material is stored or transported, it is possible to prevent the damage of the electrode active material and the impurity from being mixed into the electrode active material. In addition, it is possible to prevent that the oxide film is formed in the surface of the metal portion which comes in contact with the first and second structural members.

In the electrode body for batteries of the invention, it is desirable that the first and second structural members be each made of a conductive material.

With such a configuration, when an anode is formed from the electrode body for batteries, it is possible to make the first structural member or the second structural member serve as a collector.

In the electrode body for batteries of the invention, the first and second structural members may each include a conductive collector portion coming in contact with the surface of the metal portion and an insulative insulation portion.

With such a configuration, when the anode is formed from the electrode body for batteries, it is possible to make the collector portion serve as the collector. Further, it is possible to suppress a flow of a short-circuit current by the insulation portion.

In the electrode body for batteries of the invention, a part of the insulation portion may be provided on the outside of the collector portion. In this case, it is desirable that the insulation portion and the collector portion come in contact in the entire surfaces directly facing each other. Further, it is desirable that the insulation portion and the collector portion come in close contact in the entire surfaces directly facing each other.

With such a configuration, it is possible to suppress the flow of the short-circuit current by the insulation portion.

In the electrode body for batteries of the invention, it is desirable that the first and second structural members each include a connection terminal.

With such a configuration, when the first structural member or the second structural member is made to serve as the collector, the electrode active material portion can be electrically connected to an external circuit through the connection terminal.

In the electrode body for batteries of the invention, the metal portion may include a film portion in which first and second main surfaces come in contact with the metal, and may be divided into the first and second electrode active material portions by peeling the film portion from the metal.

With such a configuration, it is possible to easily divide the metal portion into the first and second electrode active material portions by peeling the metal of the metal portion from the film portion.

In the electrode body for batteries of the invention, it is desirable that the metal be zinc metal, calcium metal, magnesium metal, aluminum metal, iron metal, lithium metal, or sodium metal.

With such a configuration, it is possible to store and transport the metal serving as the electrode active material without forming the oxide film in the surface.

The invention provides an anode which includes the first electrode active material portion and the first structural member obtained by dividing the electrode body for batteries of the invention.

According to the anode of the invention, since the first electrode active material portion and the first structural member obtained by dividing the electrode body for batteries of the invention are provided, it is possible for the anode to serve for the storage and the transportation as the electrode body for batteries. Further, the electrode active material having the division surface obtained through the dividing without forming the oxide film can be directly assembled to the battery.

The invention also provides an anode which includes the first electrode active material portion and the first structural member, and the second electrode active material portion and the second structural member obtained by dividing the electrode body for batteries of the invention in which the first structural member and the second structural member are bonded.

According to the anode of the invention, since there are provided the first electrode active material portion and the first structural member, and the second electrode active material portion and the second structural member obtained by dividing the electrode body for batteries of the invention, it is possible for the anode to serve for the storage and the transportation as the electrode body for batteries. Further, the electrode active material having the division surface obtained through the dividing and bonding without forming the oxide film can be directly assembled to the battery. With such a configuration, since more electrode active materials can be assembled to the battery at a time by bonding the first structural member and the second structural member, a long power generation is possible and the number of times of assembling new electrode active materials to the battery can be reduced. In addition, with such a configuration, since the surface of the first electrode active material portion and the surface of the second electrode active material portion both can serve as the surface where the electrode reaction is progressed by the bonding between the first structural member and the second structural member, there is no need to distinguish the surface from the rear surface. Further, it is possible to prevent that the assembling is performed in a wrong direction.

The invention also provides a metal air battery which includes the anode of the invention, a liquid electrolyte tank which stores a liquid electrolyte, and an air electrode which serves as a cathode. The anode can be inserted into the liquid electrolyte tank and can be inserted into the inside of the liquid electrolyte tank.

According to the metal air battery of the invention, it is possible for the metal air battery to serve for the storage and the transportation as the electrode body for batteries. Further, it is possible to generate the power by supplying the divided electrode active material to the metal air battery. In addition, since the electrode active material portion is supplied to the metal air battery in a state where the oxide film is not formed in the surface and the electrode reaction can be immediately progressed in the division surface, the metal air battery of the invention has an excellent initial characteristic.

In the metal air battery of the invention, it is desirable for the anode that the division surface of the first electrode active material portion or the division surface of the second electrode active material portion be disposed on a side near the air electrode.

With such a configuration, it is possible to shorten a distance between the division surface having no oxide film in the surface of the electrode active material and the air electrode. Further, it is possible to increase the efficiency in power generation.

In the metal air battery of the invention, an ion-exchange film is further provided between the anode and the air electrode. It is desirable that the ion-exchange film have a first main surface which comes in contact with the liquid electrolyte stored in the liquid electrolyte tank and a second main surface which comes in contact with the air electrode.

With such a configuration, it is possible to restrict the type of ions migrating between the air electrode and the liquid electrolyte. Further, it is possible to suppress that metal or a carbonate compound is precipitated in the air electrode.

In addition, the electrode body for batteries of the invention includes a first metal portion which includes the metal as the electrode active material as the main component, a first structural member which comes in contact with apart of the surface of the first metal portion, and a cover member (a coating member) which comes in contact with the surface of the first metal portion serving as an electrode surface. The cover member is provided to be separated from the first metal portion in order to expose the metal of the surface of the first metal portion.

According to the invention, since the electrode body for batteries includes the first metal portion which includes the metal as the electrode active material as the main component, the electrode active material can be stored and transported without forming the oxide film in the surface by storing and transporting the electrode body for batteries.

According to the invention, since there is provided the structural member which comes in contact with a part of the surface of the first metal portion and the cover member which comes in contact with the surface of the first metal portion serving as the electrode surface, when the electrode active material is stored and transported, it is possible to prevent the damage of the electrode active material and the impurity from being mixed into the electrode active material. In addition, it is possible to prevent the oxide film from being formed in the surface of the first metal portion which comes in contact with the structural member and the cover member.

According to the invention, since there is provided the cover member (a coating member) which is provided to be separated from the first metal portion in order to expose the metal of the surface of the first metal portion, it is possible to manufacture the anode in which the metal of the surface of the first metal portion serving as the electrode surface is exposed by separating the cover member from the first metal portion. When the obtained anode is assembled to the main body of the metal air battery and the power is generated, the oxide film is not formed in the surface of which the first metal portion is exposed, so that the electrode reaction can be smoothly progressed and the power generation performance can be suppressed from being degraded. In addition, there is no need to perform a process of removing the oxide film of the first metal portion, and the cost can be reduced.

According to the invention, since there is provided the structural member coming in contact with the surface of the first metal portion, the power can be collected from the first metal portion through the structural member.

In the electrode body for batteries of the invention, it is desirable that the first structural member and the cover member both substantially cover the entire surface of the first metal portion. In addition, it is desirable that the first structural member and the cover member come in contact or close contact with the first metal portion in the entire surface facing the first metal portion. Furthermore, it is desirable that the end portion of the first structural member and the end portion of the cover member come in contact or close contact with each other.

With such a configuration, it is possible to prevent that the oxide film is formed over the substantially entire surface of the first metal portion. In addition, when the electrode active material is stored and transported, it is possible to prevent the damage of the electrode active material and the impurity from being mixed into the electrode active material.

In the electrode body for batteries of the invention, a second metal portion which includes the metal as the electrode active material as the main component is further included, and it is desirable that the first structural member include two main surfaces in which one main surface come in contact with a part of the surface of the first metal portion and the other main surface come in contact with a part of the surface of the second metal portion, and the cover member come in contact with the surface of the second metal portion serving as the electrode surface and be provided to be separated from the second metal portion in order to expose the metal of the surface of the second metal portion. In addition, a portion where the structural member and the metal portion come in contact desirably comes in close contact with a portion where the metal portion and the cover member come in close contact.

With such a configuration, since the metal portion is provided on both surfaces of the first structural member, it is possible to widen the surface where the electrode reaction is progressed in the anode manufactured from the electrode body for batteries. In addition, since the metal portion can be provided on both surfaces of the first structural member, a long power generation is possible in the anode manufactured from the electrode body for batteries and the number of times of assembling new electrode active materials to the battery can be reduced. Furthermore, since the metal portion can be provided on both surfaces of the first structural member and the first metal portion and the second metal portion both become the surface of the anode, there is no need to distinguish the surface from the rear surface. Further, it is possible to prevent that the assembling is performed in a wrong direction. In addition, in a case where the first structural member is made to serve as the collector, the first structural member can effectively collect the power from the metal portion.

In the electrode body for batteries of the invention, it is desirable that the first structural member and the cover member both substantially cover the entire surface of the second metal portion.

With such a configuration, it is possible to prevent that the oxide film is formed in the substantially entire surface of the second metal portion. In addition, when the electrode active material is stored and transported, it is possible to prevent the damage of the electrode active material and the impurity from being mixed into the electrode active material.

In the electrode body for batteries of the invention, there are further provided the second metal portion which includes the metal as the electrode active material as the main component and a third structural member which comes in contact with a part of the surface of the second metal portion. It is desirable that the cover member come in contact with the surface of the second metal portion serving as the electrode surface, and can be separated from the second metal portion in order to expose the metal of the surface of the second metal portion. In addition, the portion where the structural member and the metal portion come in contact desirably comes in close contact with the portion where the metal portion and the cover member come in contact.

With such a configuration, it is possible to manufacture an anode which includes the first metal portion and the first structural member, and an anode which includes the second metal portion and the third structural member from one electrode body for batteries. In addition, since the surface of the first metal portion and the surface of the second metal portion both can be covered by one cover member, the number of components can be reduced.

In the electrode body for batteries of the invention, it is desirable that the third structural member and the cover member both substantially cover the entire surface of the second metal portion.

With such a configuration, it is possible to prevent the oxide film from being formed in the substantially entire surface of the second metal portion. In addition, when the electrode active material is stored and transported, it is possible to prevent the damage of the electrode active material and the impurity from being mixed into the electrode active material.

In the electrode body for batteries of the invention, there are further provided the second metal portion which includes the metal as the electrode active material as the main component and the third structural member which comes in contact with a part of the surface of the second metal portion. It is desirable that the first structural member come in contact with the surface of the second metal portion serving as the electrode surface, and be separated from the second metal portion in order to expose the metal of the surface of the second metal portion. In addition, the portion where the structural member and the metal portion come in contact desirably comes in close contact with the portion where the metal portion and the cover member come in contact.

With such a configuration, it is possible to manufacture the anode having the first metal portion and the first structural member and the anode having the second metal portion and the third structural member from one electrode body for batteries. In addition, since the second metal portion can be covered by the first structural member, the number of components can be reduced. Furthermore, since the cover member can be provided to cover the surface of the first metal portion without covering the surface of the second metal portion, the cover member can be made small.

In the electrode body for batteries of the invention, it is desirable that the first and third structural members both substantially cover the entire surface of the second metal portion.

With such a configuration, it is possible to prevent the oxide film from being formed in the substantially entire surface of the second metal portion. In addition, when the electrode active material is stored and transported, it is possible to prevent the damage of the electrode active material and the impurity from being mixed into the electrode active material.

In the electrode body for batteries of the invention, it is desirable that the first or third structural member be made of a conductive material.

With such a configuration, the first or third structural member can be made to serve as the collector in the anode manufactured from the electrode body for batteries of the invention.

In the electrode body for batteries of the invention, the first or third structural member may include a conductive collector portion which comes in contact with the surface of the first or second metal portion and an insulative insulation portion.

With such a configuration, the collector portion can be made to serve as the collector in the anode manufactured from the electrode body for batteries of the invention. In addition, the occurrence of the short-circuit current can be suppressed by the insulation portion.

In the electrode body for batteries of the invention, a part of the insulation portion may be provided on the outside of the collector portion. In this case, it is desirable that the insulation portion and the collector portion come in contact in the entire surfaces directly facing each other. Further, it is desirable that the insulation portion and the collector portion come in close contact in the entire surfaces directly facing each other.

With such a configuration, it is possible to suppress the occurrence of the short-circuit current by the insulation portion.

In the electrode body for batteries of the invention, it is desirable that the first or third structural member include a connection terminal.

With such a configuration, the first or third structural member can be connected to an external circuit through the connection terminal.

In the electrode body for batteries of the invention, it is desirable that the metal be zinc metal, calcium metal, magnesium metal, aluminum metal, iron metal, lithium metal, or sodium metal.

With such a configuration, the metal of the first or second electrode active material portion can be used as the electrode active material such as the metal air battery.

The invention also provides an anode which is manufactured from the electrode body for batteries of the invention and includes a first electrode active material portion and a first structural member. The metal of the surface of the first metal portion is exposed by separating the cover member from the first metal portion.

According to the anode of the invention, since the metal of the surface of the first metal portion is provided to be exposed by separating the cover member from the first metal portion, the anode having no oxide film formed in the surface can be directly assembled to the metal air battery or the like, and the electrode reaction can be immediately progressed in the surface when the assembling is made. In addition, the cover member separated from the first metal portion can be collected for recycling.

The invention also provides an anode which is manufactured from the electrode body for batteries of the invention and includes a second metal portion and a third structural member. The metal of the surface of the second metal portion is exposed by separating the cover member or the first structural member from the second metal portion.

In the anode of the invention, since the metal of the surface of the second metal portion is exposed by separating the cover member or the first structural member from the second metal portion, the anode having no oxide film formed in the surface can be directly assembled to the metal air battery or the like, and the electrode reaction can be immediately progressed in the surface when the assembling is made. In addition, the cover member separated from the second metal portion can be collected for recycling.

The invention also provides a metal air battery which includes the anode of the invention, a liquid electrolyte tank which stores a liquid electrolyte, and an air electrode which serves as a cathode. The anode can be inserted into the liquid electrolyte tank and can be inserted into the inside of the liquid electrolyte tank.

According to the metal air battery of the invention, it is possible for the electrode body for batteries to serve for the storage and the transportation. Further, it is possible to generate the power by supplying the electrode active material obtained by separating the cover member to the metal air battery. In addition, since the metal portion is supplied to the metal air battery in a state where the metal portion has the surface where the oxide film is not formed in the surface and the metal is exposed, the electrode reaction can be immediately progressed in the metal exposing surface. Further, the metal air battery of the invention has an excellent initial characteristic.

In the metal air battery of the invention, it is desirable for the anode that the metal exposing surface of the first or second metal portion be disposed on a side near the air electrode.

With such a configuration, it is possible to shorten a distance between the metal exposing surface having no oxide film formed in the surface of the electrode active material and the air electrode. Further, it is possible to increase the efficiency in power generation.

In the metal air battery of the invention, an ion-exchange film is further provided between the anode and the air electrode. It is desirable that the ion-exchange film have a first main surface which comes in contact with the liquid electrolyte stored in the liquid electrolyte tank and a second main surface which comes in contact with the air electrode.

With such a configuration, it is possible to restrict the type of ions migrating between the air electrode and the liquid electrolyte. Further, it is possible to suppress that metal or a carbonate compound is precipitated in the air electrode.

Hereinafter, an embodiment of the invention will be described using the drawings. The configuration illustrated in the drawings or the following description is given as an example, and the scope of the invention is not limited to the drawings or the following description.

### Electrode Body for Batteries and Anode

### First Embodiment

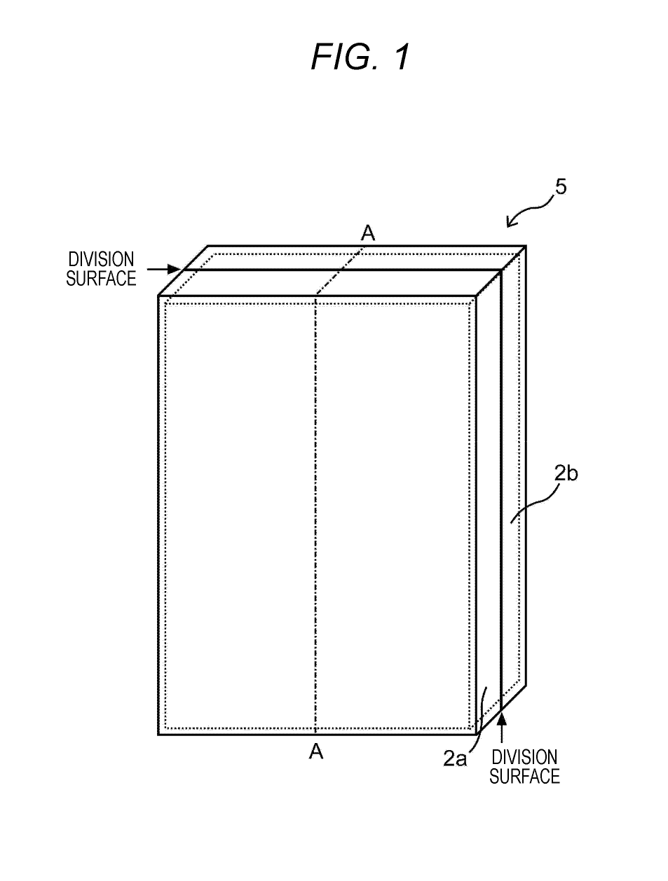

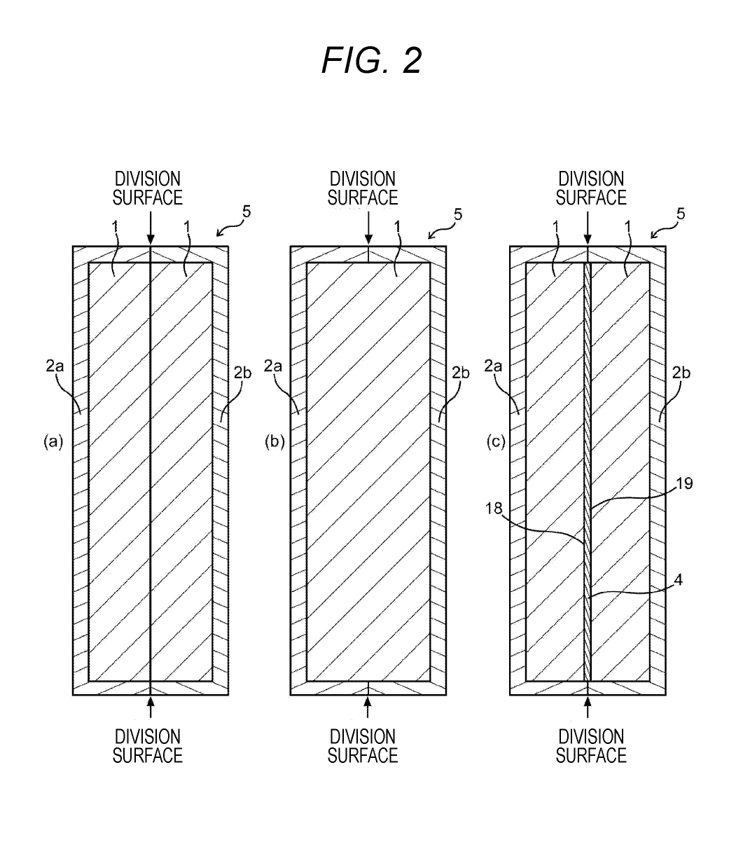

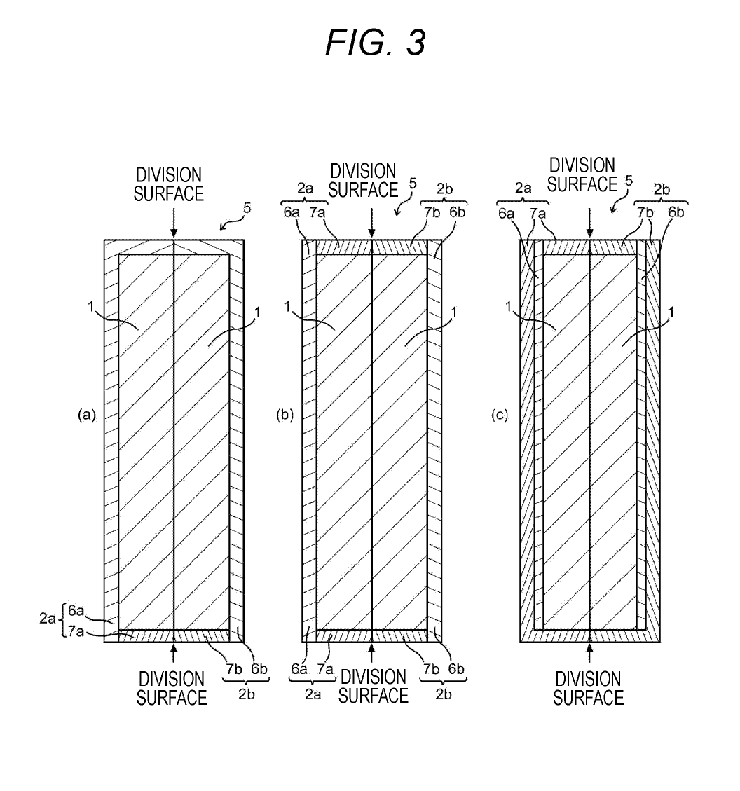

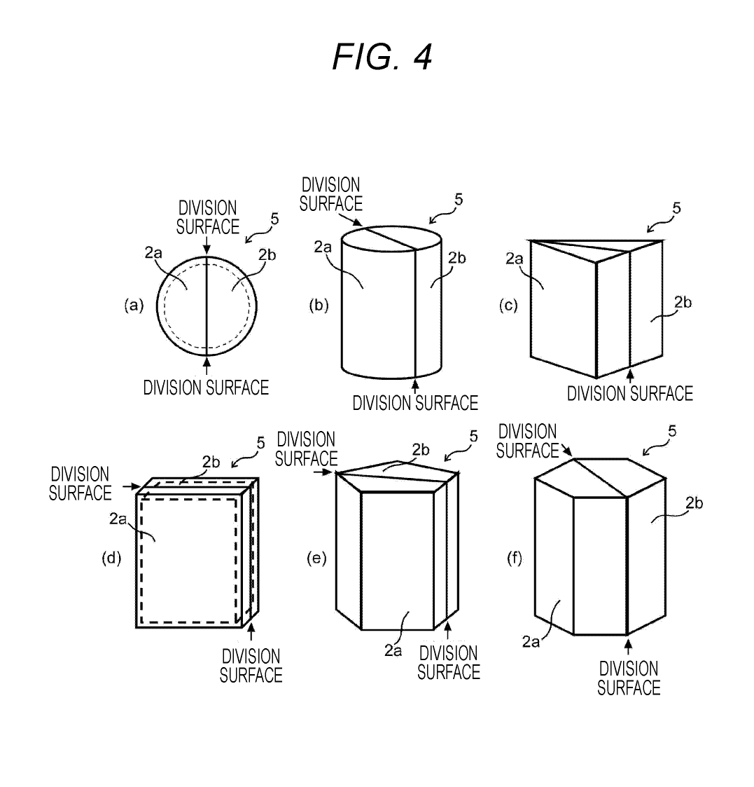

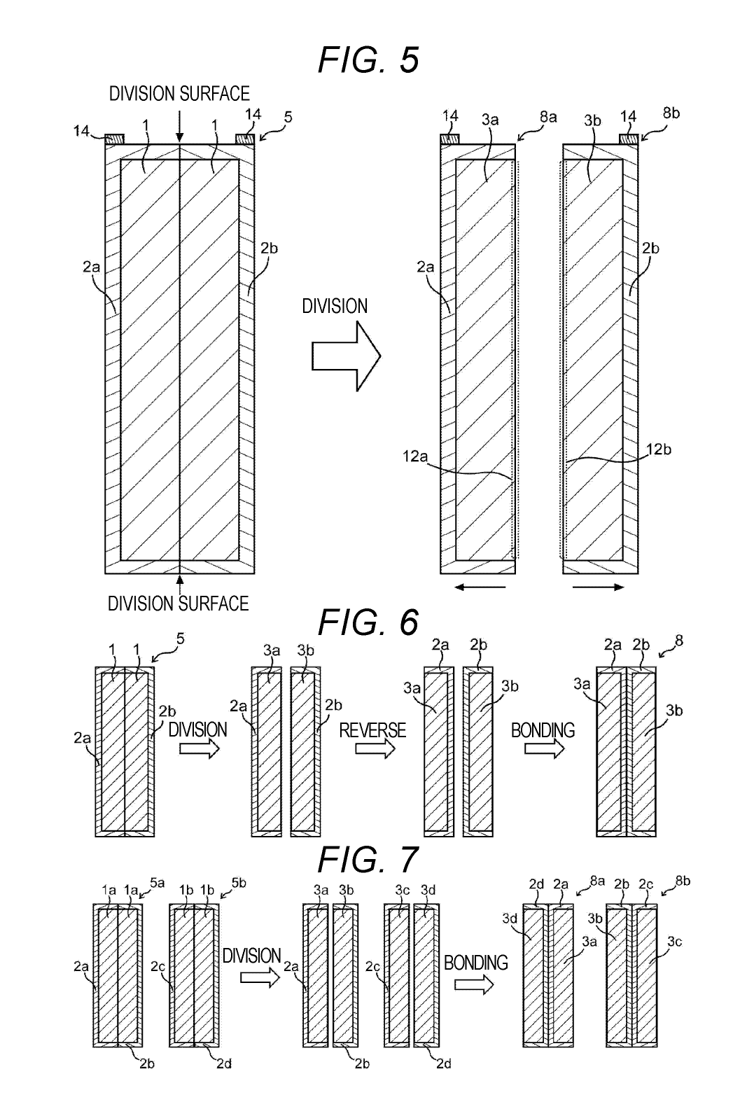

FIG. 1 is a schematic perspective view illustrating a configuration of an electrode body for batteries of this embodiment, and FIGS. 2(a) to 2(c) are each schematic cross-sectional views taken along a chain line A-A of FIG. 1. FIGS. 3(a) to 3(c) are each schematic cross-sectional views of the electrode body for batteries of this embodiment, and correspond to the schematic cross-sectional views taken along a chain line A-A of FIG. 1. FIGS. 4(a) to 4(f) are each schematic perspective views of the electrode body for batteries of this embodiment. FIGS. 5 to 8 are each explanatory diagrams of a method of manufacturing an anode of this embodiment.

An electrode body 5 for batteries of this embodiment includes a metal portion 1 which includes metal as an electrode active material as a main component and a first structural member 2a and a second structural member 2b (coating members) which cover the surface of the metal portion 1. The metal portion 1 is provided to be divided into first and second electrode active material portions 3a and 3b in order to expose the metal inside the metal portion 1. The first structural member 2a is provided to be disposed on the first electrode active material portion 3a. The second structural member 2b is provided to be disposed on the second electrode active material portion 3b.

In addition, an anode 8 of this embodiment includes the first electrode active material portion 3a and the first structural member 2a which are obtained by dividing the electrode body 5 for batteries of this embodiment.

The electrode body 5 for batteries includes the metal as the electrode active material of the battery, and is mainly formed for transporting or storing the electrode active material. In addition, there is formed the anode 8 which is assembled from the electrode body 5 for batteries into a battery such as the metal air battery, an alkaline manganese battery, or a manganese battery.

The metal portion 1 included in the electrode body 5 for batteries includes the metal as the electrode active material as a main component. The electrode active material can be transported or stored by transporting or storing the electrode body 5 for batteries including the metal portion 1.

The metal of the metal portion 1 is not particularly restricted as long as it is the metal (for example, zinc metal, aluminum metal, iron metal, magnesium metal, lithium metal, sodium metal, calcium metal, and the like) used as the electrode active material such as the metal air battery.

In addition, the metal portion 1 in the above example has been described using the metal made of a type of metal element, but the metal portion 1 may be an alloy or may include an inorganic material or an organic material.

Further, in a case where the metal of the metal portion 1 is the metal (such as lithium metal, sodium metal, and the like) having a high reactivity to moisture in the air, it is possible to suppress that the metal of the metal portion 1 reacts to the moisture in the air by blocking the metal portion 1 and the moisture in the air using the first structural member 2a and the second structural member 2b.

These electrode active materials are consumed by the electrode reaction when the anode 8 is assembled to the metal air battery or the like and a battery reaction is progressed.

The metal of the metal portion 1, for example, is manufacture by refining ores, or by reducing a metal oxide in a dry or wet process. Further, in a case where the metal as the electrode active material is manufacture by an electrolytic precipitation method, the metal may be electrolytically precipitated on the structural member 2.

In addition, the metal portion 1 may be a metal layer electrolytically precipitated on the structural member 2, or may be a metal ingot molded by drying metal slurry, or may be a metal ingot molded by fixedly pressing powdered metal.

The first structural member 2a and the second structural member 2b each cover the surface of the metal portion 1, and cover the surface of the metal portion 1. Therefore, it is possible to prevent that the surface of the metal portion 1 coming in contact with the first and second structural members 2a and 2b is exposed to the air. Further, it is possible to suppress the oxide film from being formed in the surface. In addition, it is possible to prevent that an impurity is mixed into the metal portion 1. Furthermore, since the structural member 2 can be used as a storing or transporting case, there is no need to prepare the transporting case, so that the cost can be reduced.

In addition, the entire surface of the metal portion 1 can be substantially covered by the first structural member 2a and the second structural member 2b. Therefore, it is possible to suppress the oxide film from being formed in the surface of the metal portion 1. In addition, it is possible to suppress that the electrical contact between the collector and the electrode active material portion 3 is hindered by the oxide film. In addition, it is possible to prevent that an impurity is mixed into the metal portion 1.

The first structural member 2a and the second structural member 2b, for example, are formed by a plate member or a film member. Therefore, a ratio occupied by the electrode active material in the electrode body 5 for batteries can be increased, and many electrode active materials can be stored or transported by storing or transporting the electrode body 5 for batteries. In a case where the first structural member 2a and the second structural member 2b are formed by the plate member, the first structural member 2a and the second structural member 2b can be made in a vessel shape where the metal portion 1 can be contained therein. In addition, the first structural member 2a and the second structural member 2b of the vessel shape may each have an opening.

In addition, the first structural member 2a and the second structural member 2b may be provided to make the inner space substantially separated from the external space by matching the edge of the opening of the first structural member 2a with the edge of the opening of the second structural member 2b. Therefore, the metal portion 1 can be disposed in the first structural member 2a and the second structural member 2b, and it is possible to prevent that the surface of the metal portion 1 is exposed to the air. Therefore, it is possible to suppress the oxide film from being formed in the surface of the metal portion 1.

The first structural member 2a and the second structural member 2b, for example, are made of a rigidity material. Therefore, it is possible to suppress that the metal portion 1 is damaged. In addition, the electrode body 5 for batteries is easily handled.

A part or all of the first structural member 2a or the second structural member 2b may be made of a conductive material. Therefore, when the anode 8 is formed from the electrode body 5 for batteries, it is possible to make the first structural member 2a or the second structural member 2b serve as the collector.

The surface of the conductive material portion in the first structural member 2a or the second structural member 2b may cover the metal portion 1. Therefore, it is possible to make the first structural member 2a or the second structural member 2b serve as the collector. In addition, the surface where the first structural member 2a or the second structural member 2b and the metal portion 1 covered may be a flat surface, or may be a surface formed with irregularities.

Similarly to the electrode body 5 for batteries illustrated in FIG. 1, the electrode body 5 for batteries can include the cuboid metal portion 1 and the first and second structural members 2a and 2b which cover the surface of the metal portion 1 for example.

The first and second structural members 2a and 2b are each formed of a conductive plate member such as a metal plate, and include a rectangular bottom and four side walls, and an opening is formed in the upper surface. In addition, the first structural member 2a and the second structural member 2b have almost the same shape, and the edge of the opening of the first structural member 2a and the edge of the opening of the second structural member 2b are matched with each other.

The metal portion 1 is made of metal such as zinc metal which is molded in a cuboid shape, and the surface comes in contact with the inner wall of the first structural member 2a and the second structural member 2b. In addition, the inner space of the first structural member 2a and the second structural member 2b is filled with the metal portion 1, and almost the entire surface of the metal portion 1 is covered by the first structural member 2a and the second structural member 2b.

Further, the surface including the portion where the edge of the opening of the first structural member 2a and the edge of the opening of the second structural member 2b are matched with each other becomes a surface for dividing the electrode body 5 for batteries. The electrode body 5 for batteries is divided in that surface to form the anode 8.

As illustrated in FIG. 2(a), the metal portion 1, for example, may be provided with contact surfaces of two metal ingots in the surface including the portion where the edge of the opening of the first structural member 2a and the edge of the opening of the second structural member 2b are matched with each other. Therefore, when the electrode body 5 for batteries is divided in the surface including the portion where the edge of the opening of the first structural member 2a and the edge of the opening of the second structural member 2b are matched with each other, the metal portion 1 can be easily separated in the division surface, and the metal in the metal portion 1 can be exposed. The metal portion 1 described above may be formed by pressing and bonding two metal ingots together.

In addition, the metal portion 1, for example, may be formed by one metal ingot as illustrated in FIG. 2(b). In this case, in the surface including the portion where the edge of the opening of the first structural member 2a and the edge of the opening of the second structural member 2b are matched with each other, the metal portion 1 may be separated by a knife or the like, and the metal in the metal portion 1 can be exposed.

In addition, the metal portion 1, for example, may include a film portion 4 in the surface including the portion where the edge of the opening of the first structural member 2a and the edge of the opening of the second structural member 2b are matched with each other as illustrated in FIG. 2(c). The film portion 4, for example, is formed by a plastic film, a resin film, or the like. With such a configuration of the film portion 4, the metal portion 1 can be separated, and the metal in the metal portion 1 can be exposed by peeling the metal of the metal portion 1 from the both surfaces of the film portion 4.

The first structural member 2a and the second structural member 2b may be made of the conductive material such as the metal plate as illustrated in FIGS. 2(a) to 2(c), or may be made of a collector portion 6 made of the conductive material such as the metal plate and an insulation portion 7 made of an insulative material as illustrated in FIGS. 3(a) to 3(c).

In addition, the first structural member 2a or the second structural member 2b can be provided such that the surface coming contact with the metal portion 1 is made of the conductive material. Therefore, when the electrode body 5 for batteries is divided to form the anode 8, it is possible to make the conductive material portion of the first structural member 2a or the second structural member 2b serve as the collector.

In addition, since the first structural member 2a or the second structural member 2b includes the insulation portion 7, it is possible to suppress the flow of the short-circuit current when the electrode body 5 for batteries is divided to form the anode 8. For example, in a case where the insulation portion 7 is provided in the lower portion of the electrode body 5 for batteries as illustrated in FIG. 3(a), it is possible to suppress the flow of the short-circuit current in the lower portion of the anode 8 when the anode 8 is formed and assembled to the battery. As illustrated in FIG. 3(b), in a case where the insulation portion 7 is provided in the upper portion and the lower portion of the electrode body 5 for batteries, it is possible to suppress the flow of the short-circuit current in the lower portion and the upper portion of the anode 8 when the anode 8 is formed and assembled to the battery. In addition, in a case where the collector portion 6 is provided on the main surface of the metal portion 1, and the insulation portion 7 is provided in the lower portion, the side portion, and the upper portion of the electrode body 5 for batteries as illustrated in FIG. 3(c), it is possible to suppress the flow of the short-circuit current in the lower portion, the upper portion, and the side portion of the anode 8 when the anode 8 is formed and assembled to the battery.

For example, the structural member 2 or the collector portion 6 made of a conductive material may be made of iron, nickel, tin, lead, copper, silver, platinum, gold, stainless steel, brass (copper-zinc), zinc, carbon, conductive polymers (polythiophene systems or the like), or conductive ceramics (conductive zirconia or the like).

For example, the insulation portion 7 may be made of a metal oxide (silica or the like), ceramics, or a polymer compound (a rubbery polymer or a plastic).

In FIGS. 1 to 3, the description has been made about that the electrode body 5 for batteries and the metal portion 1 are in the cuboid shape, but the electrode body 5 for batteries and the metal portion 1 are not particularly limited in that shape. For example, a circular metal portion 1 may be formed to be covered by the first structural member 2a and the second structural member 2b as illustrated in FIG. 4(a); a cylindrical metal portion 1 is formed to be covered by the first structural member 2a and the second structural member 2b as illustrated in FIG. 4(b); a triangular-pillar metal portion 1 may be formed to be covered by the first structural member 2a and the second structural member 2b as illustrated in FIG. 4(c); a pentagonal-pillar metal portion 1 may be formed to be covered by the first structural member 2a and the second structural member 2b as illustrated in FIG. 4(e); and a hexagonal-pillar metal portion 1 may be formed to be covered by the first structural member 2a and the second structural member 2b as illustrated in FIG. 4(f).

Next, a method of dividing the electrode body 5 for batteries to form the anode 8 will be described using FIGS. 5 to 8. Further, the division of the electrode body 5 for batteries may be performed in an inactive gas atmosphere. Therefore, it is possible to suppress the oxide film from being formed in the division surface.

FIG. 5 is an explanatory diagram of a method of forming two anodes 8a and 8b from one electrode body 5 for batteries. The electrode body 5 for batteries illustrated on the left side of FIG. 5 is the electrode body 5 for batteries as illustrated in FIGS. 1 and 2(a), and includes a connection terminal 14. The electrode body 5 for batteries is divided into two parts in the surface including the portion where the edge of the opening of the first structural member 2a and the edge of the opening of the second structural member 2b are matched with each other. Therefore, it is possible to form a first anode 8a which includes the first electrode active material portion 3a and the first structural member 2a formed by dividing the metal portion 1, and a second anode 8b which includes the second electrode active material portion 3b and the second structural member 2b formed by dividing the metal portion 1.

Further, the connection terminal 14 is provided to come in contact with the conductive portion of the first structural member 2a or the second structural member 2b, and is not particularly limited in position. For example, the connection terminal 14 can be provided at a position to be easily connected to a supporting member 16 when the anode 8 is assembled to the battery. In the electrode body 5 for batteries illustrated in FIG. 1, the connection terminal 14 can be provided in a portion coming in contact with the first structural member 2a of the upper or lower surface and a portion coming in contact with the second structural member 2b of the upper or lower surface.

In addition, like the connection terminals 14 included in the electrode body 5 for batteries illustrated in FIG. 5, when a plurality of anodes 8 are formed from the electrode body 5 for batteries, the connection terminals 14 can be provided in the electrode body 5 for batteries such that the connection terminals 14 have the same position in the plurality of anodes 8. Therefore, there is no need to change a connection position between the supporting member 16 and the connection terminal 14 of each anode 8, and the anode 8 can be easily supplied to a metal air battery 45. In addition, one supporting member 16 is connected to the connection terminal 14 provided in each of two anodes 8, and two anodes 8 can be collectively supplied to the metal air battery 45. Therefore, it is possible to skip a process of bonding two anodes 8.

The number of anodes 8 formed by dividing one electrode body 5 for batteries is not limited to “2”, and for example may be “3”, “4”, “5”, “6”, and so on. In this case, the electrode body 5 for batteries can include the structural members 2 of the same number as the division number.

As a method of dividing the electrode body 5 for batteries, for example, the metal portion 1 may be divided into the first electrode active material portion 3a and the second electrode active material portion 3b by peeling the contact surface of the metal portion 1; the metal portion 1 may be divided into the first electrode active material portion 3a and the second electrode active material portion 3b by inserting a knife or the like into the surface including the portion where the edge of the opening of the first structural member 2a and the edge of the opening of the second structural member 2b are matched with each other; and the metal portion 1 may be divided into the first electrode active material portion 3a and the second electrode active material portion 3b by peeling the film portion 4 from the metal of the metal portion 1 as illustrated in FIG. 2(c).

In addition, the surface for dividing the electrode body 5 for batteries may be a flat surface, a surface formed with irregularities, or a surface formed with steps.

In this way, when the metal portion 1 is divided into the first electrode active material portion 3a and the second electrode active material portion 3b to form the first anode 8a and the second anode 8b, the metal in the metal portion 1 is exposed in the division surface 12a of the first electrode active material portion 3a included in the first anode 8a and in the division surface 12b of the second electrode active material portion 3b included in the second anode 8b, and the oxide film is not formed in the surface. Therefore, when the first anode 8a or the second anode 8b is assembled to the battery such as the metal air battery, the battery reaction can be immediately progressed in the division surface 12. Accordingly, it is possible to improve the initial characteristic of the battery.

Further, in the first anode 8a and the second anode 8b, it is possible to make the first structural member 2a and the second structural member 2b serve as the collector.

In FIG. 5, the description has been made about the method of dividing one electrode body 5 for batteries to form two anodes 8a and 8b. As illustrated in FIG. 6, one anode 8 may be formed by dividing one electrode body 5 for batteries into two parts, reversing the divided electrode bodies 5 for batteries, and bonding the first structural member 2a and the second structural member 2b.

In addition, as illustrated in FIG. 7, the anode 8 may be formed by dividing a first electrode body 5a for batteries and a second electrode body 5b for batteries, and bonding the electrode bodies for batteries obtained by dividing the first electrode body 5a for batteries and the electrode bodies for batteries obtained by dividing the second electrode body 5b for batteries.

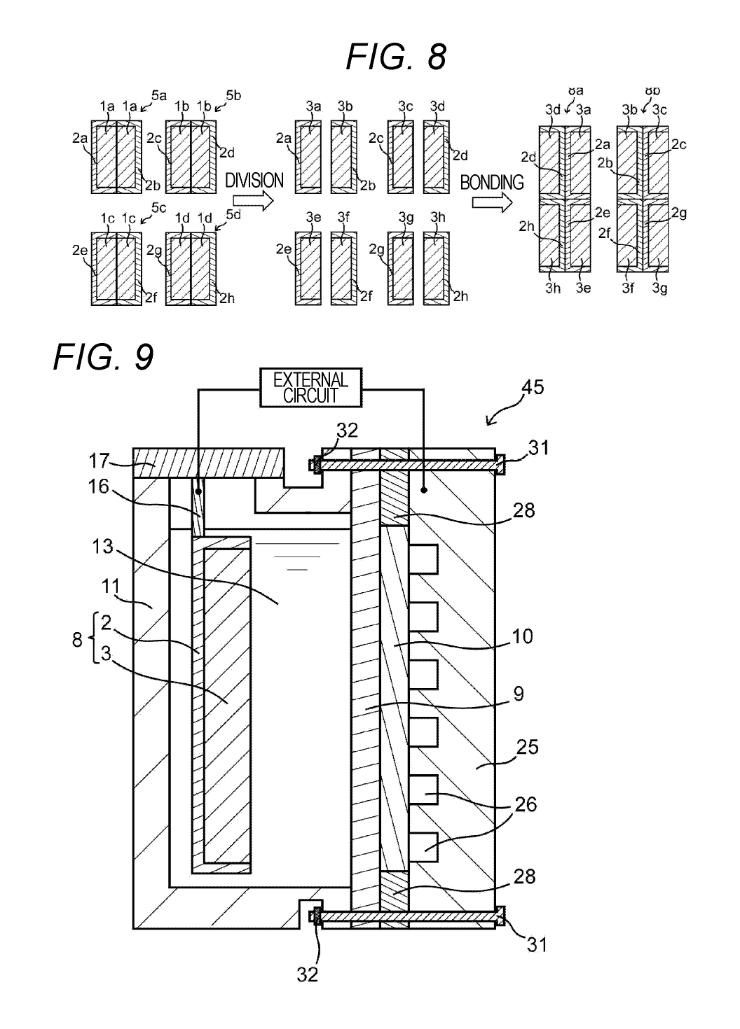

In FIGS. 6 and 7, the description has been made about the method of bonding two divided electrode bodies for batteries to form one anode 8, but one anode 8 may be formed by boning four divided electrode bodies for batteries as illustrated in FIG. 8. In addition, similarly, one anode 8 may be formed by bonding “six”, “eight”, or “ten” divided electrode bodies for batteries.

### Electrode Body for Batteries and Anode

### Second Embodiment

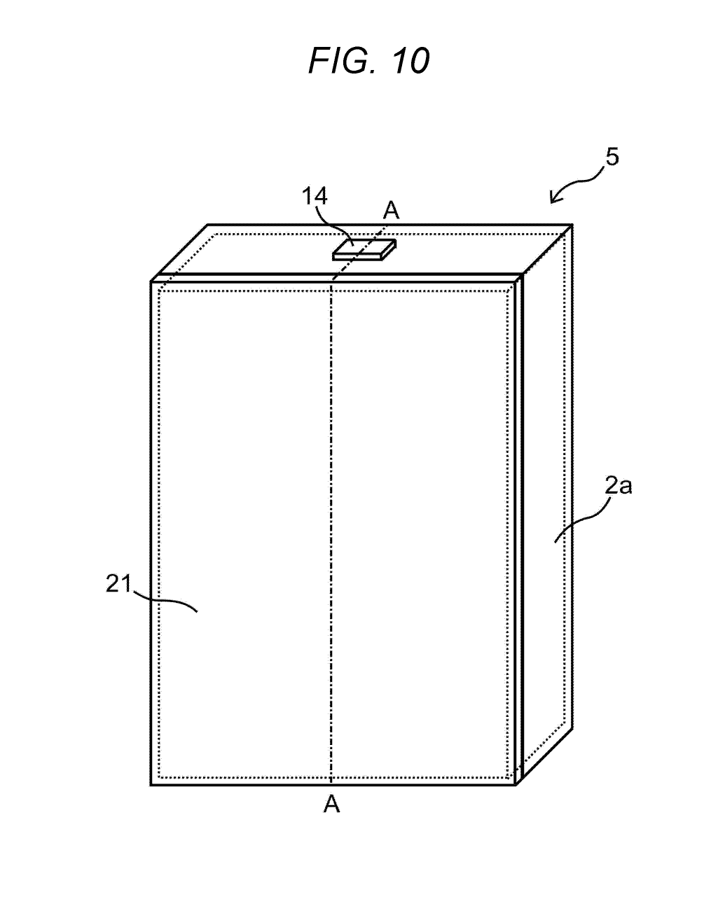

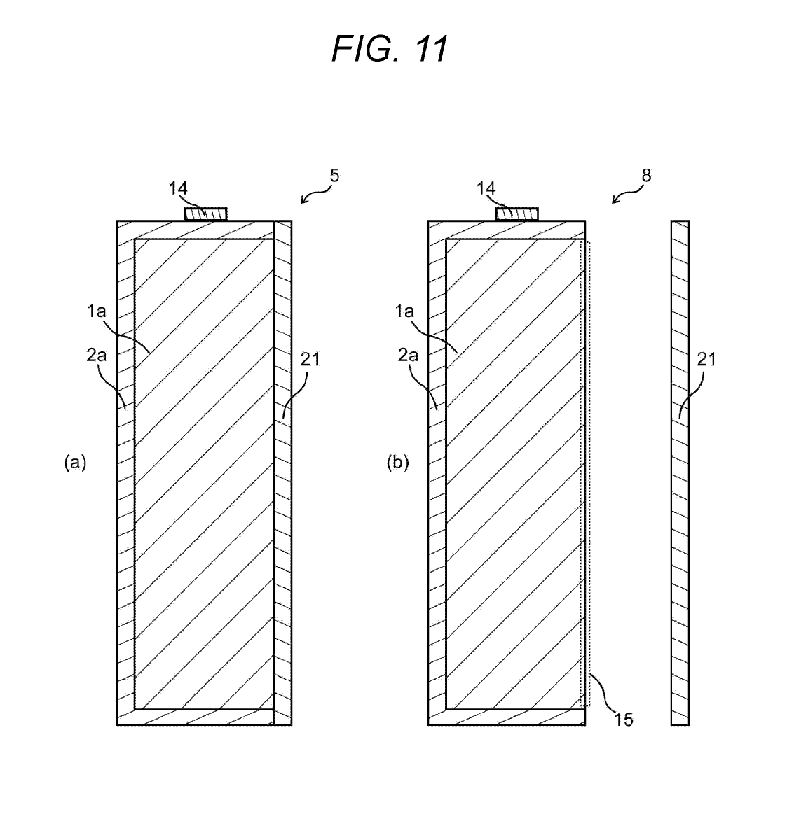

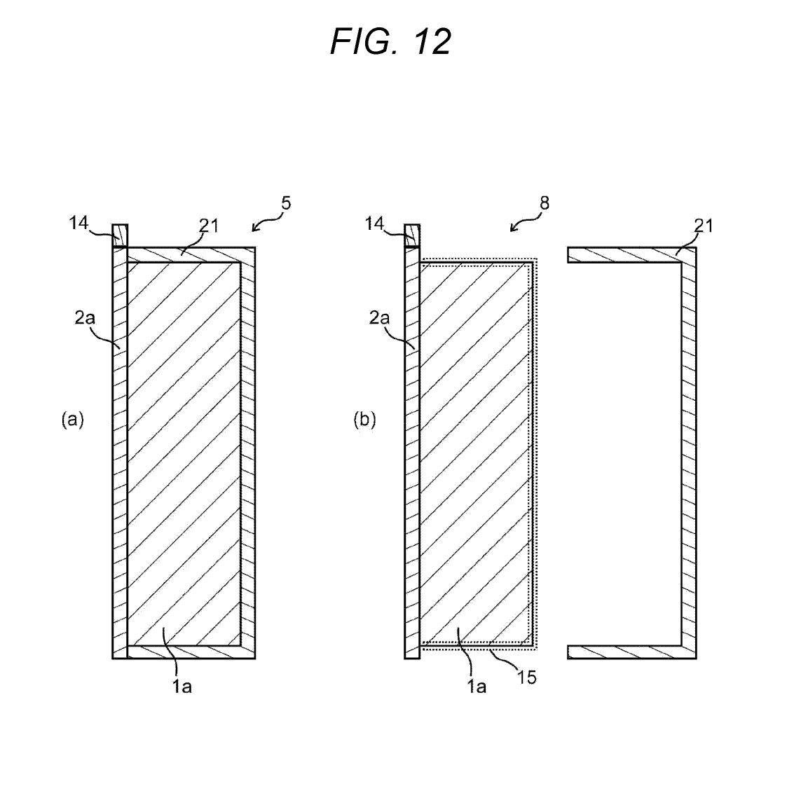

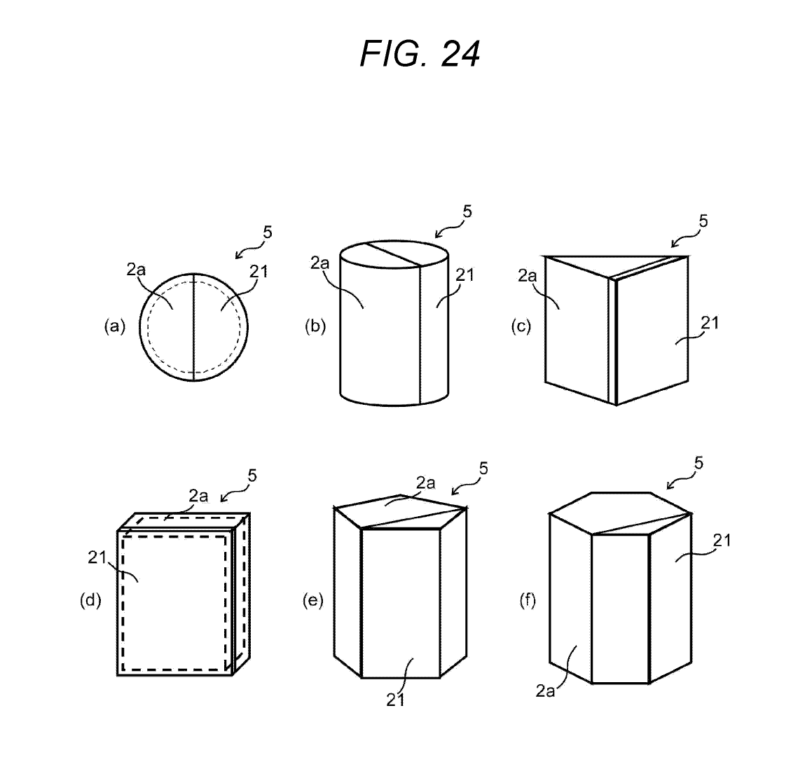

FIG. 10 is a schematic perspective view illustrating a configuration of the electrode body for batteries of this embodiment, FIG. 11(a) is a schematic cross-sectional view of the electrode body for batteries taken along a chain line A-A of FIG. 10, and FIG. 11(b) is a schematic cross-sectional view of an anode which is manufactured by separating a cover member included in the electrode body for batteries illustrated in FIG. 11(a) from the metal portion. FIGS. 12 to 23 are schematic cross-sectional views of the electrode body for batteries of this embodiment, and schematic cross-sectional views of the anode which is manufactured from the electrode body for batteries. FIGS. 24(a) to 24(f) are each schematic perspective views of the electrode body for batteries of this embodiment.

The electrode body 5 for batteries of this embodiment includes a first metal portion 1a which includes the metal as the electrode active material as the main component, the first structural member 2a which comes in contact with the surface of the first metal portion 1a, and a cover member 21 (a coating member) which comes in contact with the surface of the first metal portion 1a. The cover member 21 is configured to be separated from the first metal portion 1a in order to expose the metal of the surface of the first metal portion 1a. In addition, a portion where the structural member 2 and the metal portion 1 come in contact desirably comes in close contact with a portion where the metal portion 1 and the cover member 21 come in contact.

In addition, the electrode body 5 for batteries of this embodiment may further include a second metal portion 1b and the second structural member 2b.

The anode 8a of this embodiment includes the first metal portion 1a and the first structural member 2a. The metal of the surface of the first metal portion 1a is exposed by separating the cover member 21 from the first metal portion 1a.

The anode 8b of this embodiment includes the second metal portion 1b and the second structural member 2b. The metal of the surface of the second metal portion 1b is exposed by separating the cover member 21 or the first structural member 2a from the second metal portion 1b.

The descriptions on the electrode body 5 for batteries, the metal portion 1, the metal of the metal portion 1, and the electrode active material are identical with or similar to the electrode body for batteries of the above-mentioned first embodiment in a scope where the contents are compossible.

The first structural member 2a and the cover member 21 come in contact with the surface of the first metal portion 1a, and cover the surface of the first metal portion 1a. In addition, the portions where the metal portion 1 and the cover member 21 come in contact come desirably come in close contact with each other. Therefore, it is possible to prevent that the surface of the first metal portion 1a where the first structural member 2a and the cover member 21 come in contact is exposed to the air. Further, it is possible to prevent the oxide film from being formed in the surface. In addition, it is possible to prevent that an impurity is mixed into the first metal portion 1a. Furthermore, since the first structural member 2a and the cover member 21 can be used as the storing or transporting case, there is no need to prepare the transporting case, so that the cost can be reduced.

In addition, the entire surface of the first metal portion 1a can be substantially covered by the first structural member 2a and the cover member 21. Therefore, it is possible to prevent the oxide film from being formed in the surface of the first metal portion 1a. In addition, it is possible to suppress that the electrical contact between the collector and the metal portion 1 is hindered by the oxide film. In addition, it is possible to prevent that an impurity is mixed into the first metal portion 1a.

The cover member 21 is provided to be separated from the first metal portion 1a in order to expose the metal of the surface of the first metal portion 1a. Since the oxide film is substantially not formed in the surface of the first metal portion 1a exposed by separating the cover member 21, it is possible for the battery to which the anode 8 manufactured by separating the cover member 21 from the first metal portion 1a is assembled to have an excellent initial characteristic.

The second structural member 2b and the cover member 21, or the second structural member 2b and the first structural member 2a come in contact with the surface of the second metal portion 1b, and cover the surface of the second metal portion 1b. In addition, the portion where the structural member 2 and the metal portion 1 come in contact desirably comes in close contact with the portion where the metal portion 1 and the cover member 21 come in contact. Therefore, it is possible to prevent that the surface of the second metal portion 1b which comes in contact with the second structural member 2b and the cover member 21 or the second structural member 2b and the first structural member 2a is exposed to the air. Further, it is possible to prevent the oxide film from being formed in the surface. In addition, it is possible to prevent that an impurity is mixed into the second metal portion 1b. Furthermore, since the second structural member 2b and the cover member 21 or the second structural member 2b and the first structural member 2a can be used as the storing or transporting case, there is no need to prepare the transporting case, so that the cost can be reduced.

In addition, the entire surface of the second metal portion 1b can be substantially covered by the second structural member 2b and the cover member 21 or the second structural member 2b and the first structural member 2a. Therefore, it is possible to prevent the oxide film from being formed in the surface of the second metal portion 1b. In addition, it is possible to suppress that the electrical contact between the collector and the metal portion 1 is hindered by the oxide film. In addition, it is possible to prevent that an impurity is mixed into the first metal portion 1a.

The cover member 21 or the first structural member 2a is provided to be separated from the second metal portion 1b in order to expose the metal of the surface of the second metal portion 1b. Since the oxide film is substantially not formed in the surface of the second metal portion 1b exposed by separating the cover member 21 or the first structural member 2a, it is possible for the battery to which the anode 8 manufactured by separating the cover member 21 or the first structural member 2a from the second metal portion 1b is assembled to have an excellent initial characteristic.

The first structural member 2a and the second structural member 2b, for example, are formed by a plate member or a film member. Therefore, a ratio occupied by the electrode active material in the electrode body 5 for batteries can be increased, and many electrode active materials can be stored or transported by storing or transporting the electrode body 5 for batteries. The first structural member 2a or the second structural member 2b, for example, is formed by a metal plate.

In a case where the first structural member 2a or the second structural member 2b is formed by the plate member, the first structural member 2a or the second structural member 2b can be made in a box shape where the metal portion 1 can be contained therein. In addition, the first structural member 2a or the second structural member 2b of the box shape may have an opening.

The first structural member 2a or the second structural member 2b, for example, is made of a rigidity material. Therefore, it is possible to suppress that the metal portion 1 is damaged. In addition, the electrode body 5 for batteries is easily handled.

A part or all of the first structural member 2a or the second structural member 2b may be made of a conductive material. Therefore, when the anode 8 is formed from the electrode body 5 for batteries, it is possible to make the first structural member 2a or the second structural member 2b serve as the collector. In addition, the first structural member 2a or the second structural member 2b can include the collector portion 6 formed by the conductive material and the insulation portion 7 formed by an insulative material.

The surface of the conductive material portion in the first structural member 2a or the second structural member 2b may come in contact with the metal portion 1. Therefore, it is possible to make the first structural member 2a or the second structural member 2b serve as the collector. In addition, the surface where the first structural member 2a or the second structural member 2b and the metal portion 1 come in contact may be a flat surface, or may be a surface formed with irregularities.

For example, the structural member 2 or the collector portion 6 made of a conductive material may be made of iron, nickel, tin, lead, copper, silver, platinum, gold, stainless steel, brass (copper-zinc), zinc, carbon, conductive polymers (polythiophene systems or the like), or conductive ceramics (conductive zirconia or the like).

For example, the insulation portion 7 may be made of a metal oxide (silica or the like), ceramics, or a polymer compound (a rubbery polymer or a plastic).

The cover member 21, for example, is formed by a plate member or a film member. Therefore, a ratio occupied by the electrode active material in the electrode body 5 for batteries can be increased, and many electrode active materials can be stored or transported by storing or transporting the electrode body 5 for batteries.

The cover member 21, for example, is formed by a metal plate, a plastic plate, a resin plate, a plastic film, a resin film, a metal foil, or the like.

The shape of the electrode body 5 for batteries of this embodiment is not particularly limited. For example, a circular metal portion 1 covered by the structural member 2 and the cover member 21 may be formed like the electrode body 5 for batteries illustrated in FIG. 24(a); a cylindrical metal portion 1 covered by the structural member 2 and the cover member 21 may be formed like the electrode body 5 for batteries illustrated in FIG. 24(b); a triangular-pillar metal portion 1 covered by the structural member 2 and the cover member 21 may be formed like the electrode body 5 for batteries illustrated in FIG. 24(c); a rectangular-pillar metal portion 1 covered by the structural member 2 and the cover member 21 may be formed like the electrode body 5 for batteries illustrated in FIG. 24(d); a pentagonal-pillar metal portion 1 covered by the structural member 2 and the cover member 21 may be formed like the electrode body 5 for batteries illustrated in FIG. 24(e); and a hexagonal-pillar metal portion 1 covered by the structural member 2 and the cover member 21 may be formed like the electrode body 5 for batteries illustrated in FIG. 24(f).

Herein, the description will be made about a case where the electrode body 5 for batteries of this embodiment has the rectangular-pillar metal portion 1.

FIG. 10 is a schematic perspective view of the electrode body 5 for batteries in which the rectangular-pillar first metal portion 1a is covered by the plate first structural member 2a and the plate cover member 21, and FIG. 11(a) is a schematic cross-sectional view taken along a chain line A-A of FIG. 10. In the electrode body 5 for batteries, the first metal portion 1a is contained in the first structural member 2a of the box shape, and the cover member 21 closes the opening of the first structural member 2a of the box shape. In addition, the connection terminal 14 is provided on the first structural member 2a. It is possible to suppress that the metal of the first metal portion 1a comes in contact with the air by storing and transporting the electrode body 5 for batteries. Therefore, the electrode active material can be stored and transported while preventing the oxide film from being formed in the surface of the first metal portion 1a.

Further, the connection terminal 14 is provided to come in contact with a conductive portion of the first structural member 2a, and the position thereof is not particularly restricted. In addition, such a configuration will be the same even in a case where the connection terminal 14 is provided in the second structural member 2b.

FIG. 11(b) is a schematic cross-sectional view of the anode 8 manufactured from the electrode body 5 for batteries illustrated in FIGS. 10 and 11(a). The anode 8 illustrated in FIG. 11(b) can be manufacture by separating the cover member 21 included in the electrode body 5 for batteries illustrated in FIGS. 10 and 11(a) from the first metal portion 1a. Therefore, it is possible to expose the surface (a metal exposing surface 15) covered by the cover member 21 in the surface of the first metal portion 1a.

The anode 8 illustrated in FIG. 11(b) can be manufactured immediately before the anode 8 is assembled to the main body of the metal air battery. Therefore, it is possible to prevent the oxide film from being formed in the exposed surface of the first metal portion 1a of the anode 8.

When the anode 8 illustrated in FIG. 11(b) is assembled to the main body of the metal air battery and the power is generated by the metal air battery 45, the oxide film is substantially not formed in the metal exposing surface 15 of the anode 8, so that the electrode reaction can be immediately progressed in the metal exposing surface 15. Therefore, it is possible to improve the initial characteristic of the metal air battery 45.

In addition, with this configuration, when the electrode reaction is progressed in the anode 8, it is possible to suppress that a large ingot of the electrode active material peels off.

FIG. 12(a) is a schematic cross-sectional view of the electrode body 5 for batteries, and FIG. 12(b) is a schematic cross-sectional view of the anode 8 manufactured from the electrode body 5 for batteries of FIG. 12(a). In the electrode body 5 for batteries, the cover member 21 is formed in a box shape, and the first metal portion 1a is contained in the cover member 21.

With such a configuration, it is possible to widen the surface of the metal portion 1 where the electrode reaction is progressed in the anode 8.

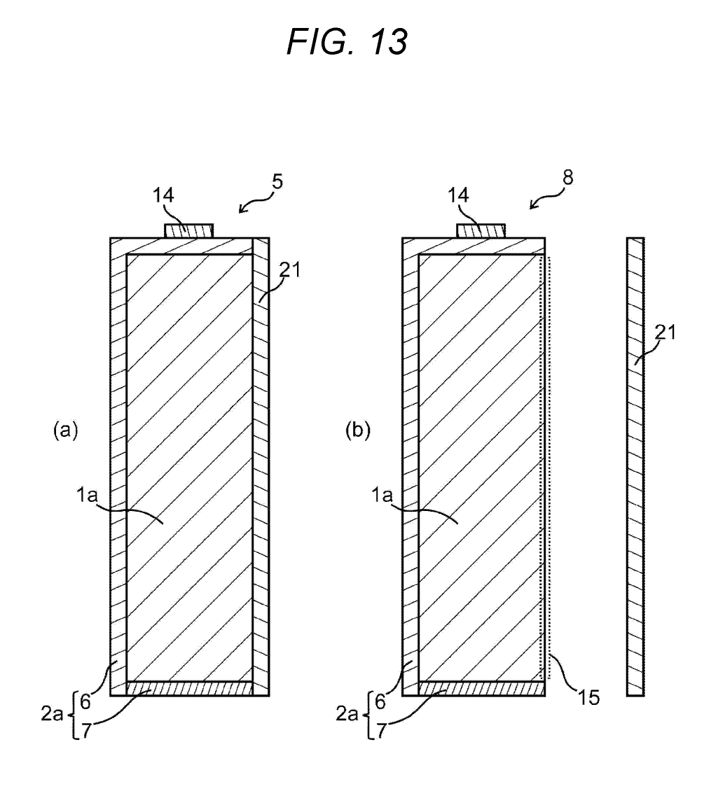

FIG. 13(a) is a schematic cross-sectional view of the electrode body 5 for batteries, and FIG. 13(b) is a schematic cross-sectional view of the anode 8 manufactured from the electrode body 5 for batteries of FIG. 13(a). In the electrode body 5 for batteries, the lower portion of the first structural member 2a is formed by the insulation portion 7, and the side portion and the upper portion thereof are formed by the collector portion 6.

With such a configuration, when the electrode reaction is progressed in the anode 8, it is possible to suppress that the anode 8 and the bottom of a liquid electrolyte tank 11 of the metal air battery 45 are electrically connected to each other. Further, it is possible to suppress the flow of the short-circuit current.

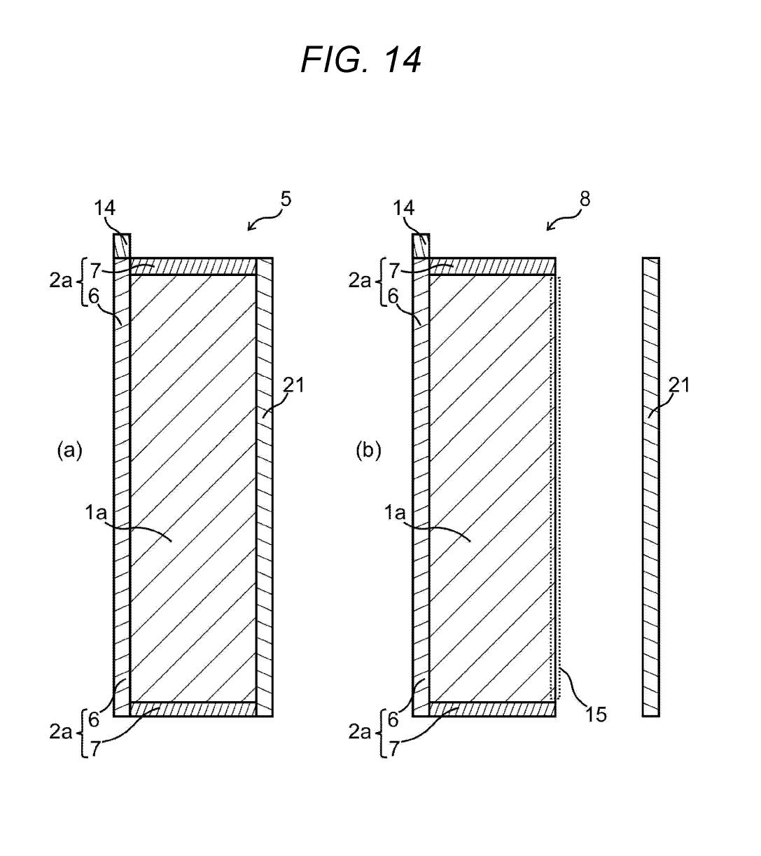

FIG. 14(a) is a schematic cross-sectional view of the electrode body 5 for batteries, and FIG. 14(b) is a schematic cross-sectional view of the anode 8 manufactured from the electrode body 5 for batteries of FIG. 14(a). In the electrode body 5 for batteries, the upper portion and the lower portion of the first structural member 2a are formed by the insulation portion 7, and the side portion thereof is formed by the collector portion 6.

With such a configuration, when the electrode reaction is progressed in the anode 8, it is possible to suppress that the anode 8 and the bottom or the upper portion of the liquid electrolyte tank 11 of the metal air battery 45 are electrically connected to each other. Further, it is possible to suppress the flow of the short-circuit current.

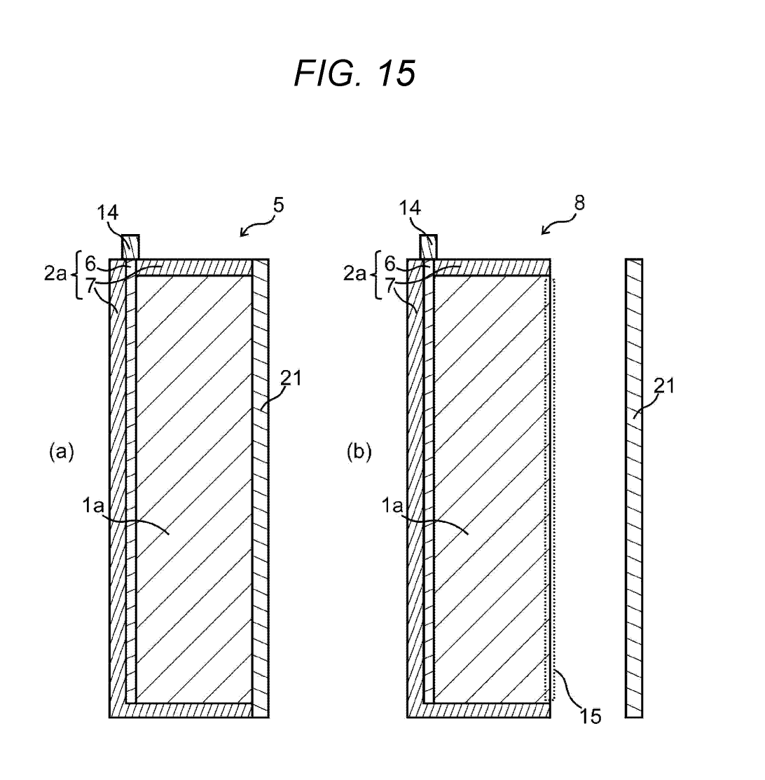

FIG. 15(a) is a schematic cross-sectional view of the electrode body 5 for batteries, and FIG. 15(b) is a schematic cross-sectional view of the anode 8 manufactured from the electrode body 5 for batteries of FIG. 15(a). In the electrode body 5 for batteries, the first structural member 2a includes the collector portion 6 which is provided on the side surface of the first metal portion 1a and the insulation portion 7 which is provided on the upper surface of the first metal portion 1a and on the lower surface of the first metal portion 1a outside the collector portion 6.

With such a configuration, when the electrode reaction is progressed in the anode 8, it is possible to suppress that the anode 8 and the liquid electrolyte tank 11 of the metal air battery 45 are electrically connected to each other. Further, it is possible to suppress the flow of the short-circuit current.

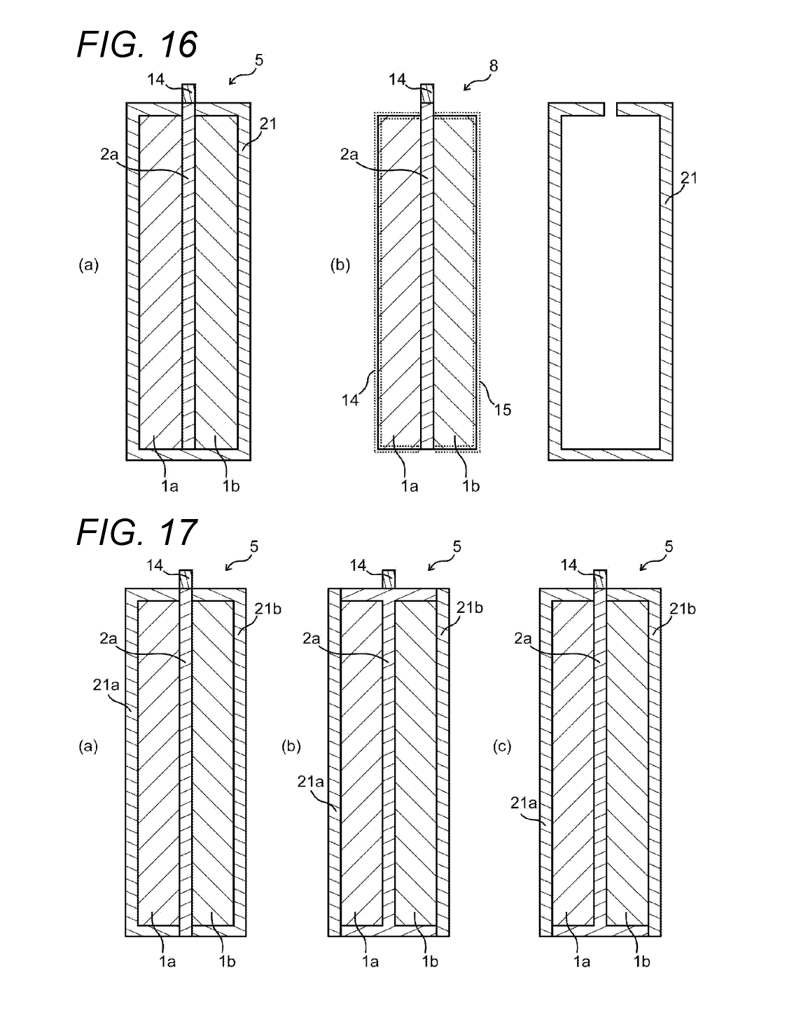

FIG. 16(a) is a schematic cross-sectional view of the electrode body 5 for batteries, and FIG. 16(b) is a schematic cross-sectional view of the anode 8 manufactured from the electrode body 5 for batteries of FIG. 16(a). The electrode body 5 for batteries includes the first metal portion 1a and the second metal portion 1b, one main surface of the first structural member 2a covers the surface of the first metal portion 1a, and the other main surface of the first structural member 2a covers the surface of the second metal portion 1b. In addition, the cover member 21 is provided to surround the first metal portion 1a and the second metal portion 1b.

With such a configuration, when the electrode reaction is progressed in the anode 8, it is possible to widen the surface of the metal portion 1 where the electrode reaction is progressed. Further, in the case of such a configuration, the cover member 21 can be made of a flexible material such as a plastic film, a resin film, or a metal foil.

In addition, in such a configuration, the first metal portion 1a and the second metal portion 1b may be integrally bonded to the lower portion of the first structural member 2a.

FIGS. 17(a) to 17(c) are each schematic cross-sectional views of the electrode body 5 for batteries. In FIGS. 17(a) to 17(c), the electrode body 5 for batteries includes the first metal portion 1a and the second metal portion 1b, one main surface of the first structural member 2a covers the surface of the first metal portion 1a, and the other main surface of the first structural member 2a covers the surface of the second metal portion 1b. In addition, the electrode body 5 for batteries includes a first cover member 21a which covers the surface of the first metal portion 1a and a second cover member 21b which covers the surface of the second metal portion 1b. In addition, the first structural member 2a included in the electrode body 5 for batteries illustrated in FIG. 17(a) is formed in a plate shape. The first structural member 2a included in the electrode body 5 for batteries illustrated in FIG. 17(b) is formed in an H shape in which the upper portion and the lower portion each have an extending portion, and the upper surface and the lower surface of the metal portion 1 are also covered by the first structural member 2a. The first structural member 2a included in the electrode body 5 for batteries illustrated in FIG. 17(c) is formed in a T shape in which the lower portion has an extending portion, and the lower surface of the metal portion 1 is also covered by the first structural member 2a. Further, the extending portion of the first structural member 2a illustrated in FIGS. 17(b) and 17(c) may be made of an insulative material. In addition, the surface of the metal portion 1 in a vertical direction in the cross-sectional view of FIG. 17 may be covered by the cover member 21, or the first structural member 2a may include the extending portion and be covered by the extending portion.

In this way, since the surface of the first metal portion 1a is covered by the first cover member 21a and the surface of the second metal portion 1b is covered by the second cover member 21b, the cover member 21 can be easily separated from the metal portion 1 even in a case where the cover member 21 is made of a rigidity material.

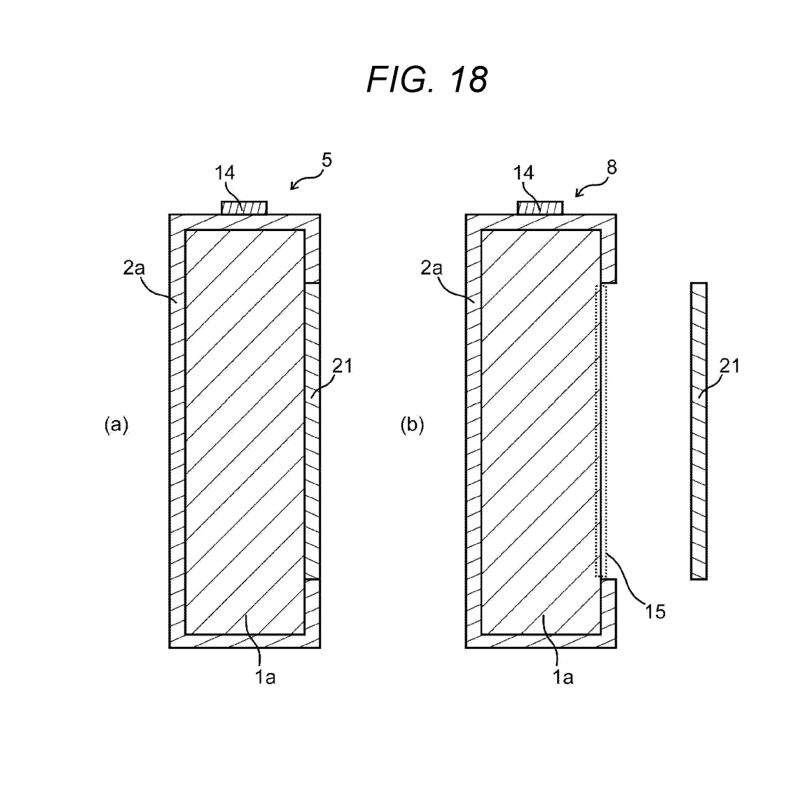

FIG. 18(a) is a schematic cross-sectional view of the electrode body 5 for batteries, and FIG. 18(b) is a schematic cross-sectional view of the anode 8 manufactured from the electrode body 5 for batteries of FIG. 18(a). The electrode body 5 for batteries is formed in a box shape, and includes the first structural member 2a which has an opening in a part of the side surface, the first metal portion 1a which is contained in the first structural member 2a, and the cover member 21 which closes the opening to be engaged with the opening of the first structural member 2a.

With such a configuration, when the electrode reaction is progressed in the anode 8, it is possible to suppress that a large ingot of the electrode active material peels off.

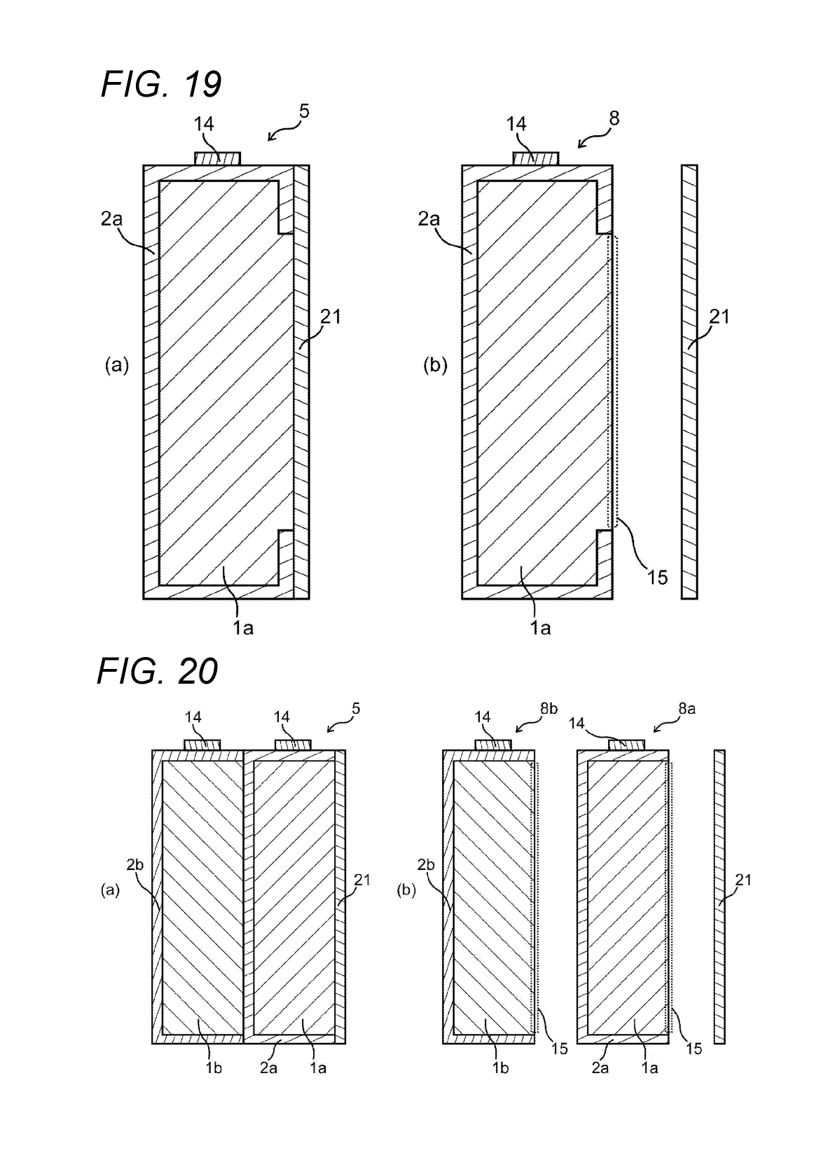

FIG. 19(a) is a schematic cross-sectional view of the electrode body 5 for batteries, and FIG. 19(b) is a schematic cross-sectional view of the anode 8 manufactured from the electrode body 5 for batteries of FIG. 19(a). The electrode body 5 for batteries is formed in a box shape, and includes the first structural member 2a which has an opening in a part of the side surface, the first metal portion 1a which is contained in the first structural member 2a, and the cover member 21 which closes the opening to cover the opening of the first structural member 2a.

With such a configuration, when the electrode reaction is progressed in the anode 8, it is possible to suppress that a large ingot of the electrode active material peels off.

FIG. 20(a) is a schematic cross-sectional view of the electrode body 5 for batteries, and FIG. 20(b) is a schematic cross-sectional view of the anodes 8a and 8b manufactured from the electrode body 5 for batteries of FIG. 20(a). The electrode body 5 for batteries includes the first structural member 2a of a box shape, the second structural member 2b of a box shape, the first metal portion 1a which is contained in the first structural member 2a of a box shape, the second metal portion 1b which is contained in the second structural member 2b of a box shape, and the cover member 21 which closes the opening of the first structural member 2a and comes in contact with the first metal portion 1a. In addition, the opening of the second structural member 2b is closed by the first structural member 2a which comes in contact with the second metal portion 1b.

With such a configuration, two anodes 8 can be manufactured from one electrode body 5 for batteries, and the electrode active material can be effectively stored and transported. In addition, since the opening of the second structural member 2b can be closed by the first structural member 2a, the number of components can be reduced.

Herein, the description has been made about the electrode body 5 for batteries having two metal portions 1, but the number of metal portions 1 included in the electrode body 5 for batteries of this embodiment may be “3”, “4”, “5”, “6”, “7”, “8”, or “10”. Even in this case, the metal portions 1 are contained in the corresponding structural members, and are connected in a daisy chain.

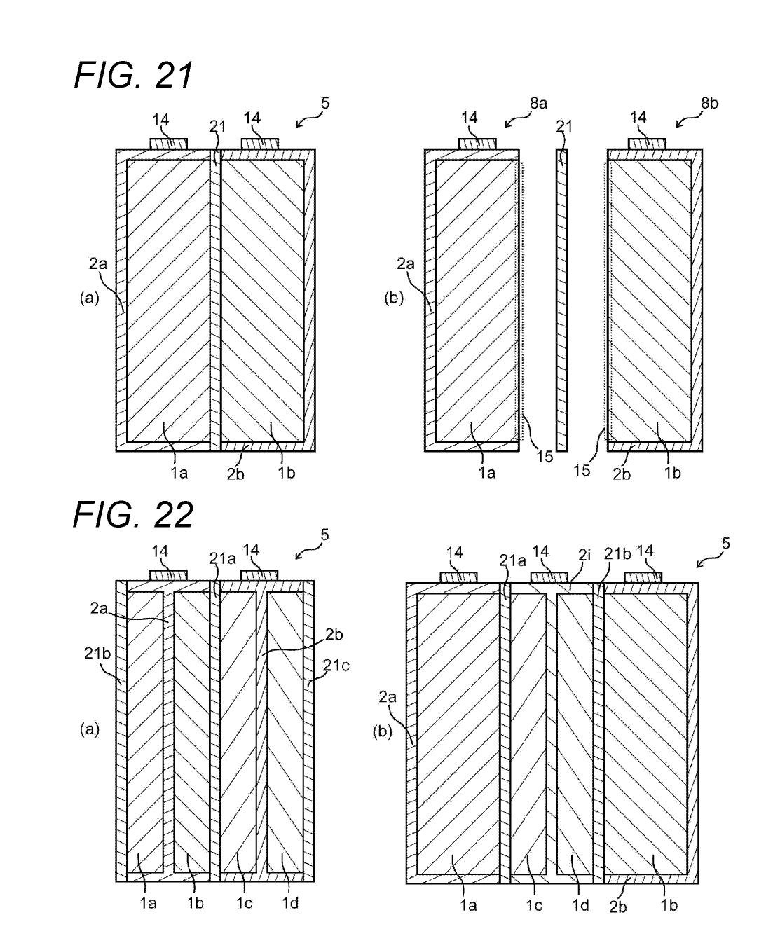

FIG. 21(a) is a schematic cross-sectional view of the electrode body 5 for batteries, and FIG. 21(b) is a schematic cross-sectional view of the anodes 8a and 8b manufactured from the electrode body 5 for batteries of FIG. 21(a). The electrode body 5 for batteries includes the first structural member 2a of a box shape, the second structural member 2b of a box shape, the first metal portion 1a which is contained in the first structural member 2a of a box shape, the second metal portion 1b which is contained in the second structural member 2b of a box shape, and the cover member 21 which closes the opening of the first structural member 2a by one main surface and closes the opening of the second structural member 2b by the other main surface.

With such a configuration, two anodes 8 can be manufactured from one electrode body 5 for batteries, and the electrode active material can be effectively stored and transported. In addition, since the opening of the first structural member 2a and the opening of the second structural member 2b both can be closed by one cover member 21, the number of components can be reduced.

FIGS. 22(a) and 22(b) are each schematic cross-sectional views of the electrode body 5 for batteries. The electrode body 5 for batteries illustrated in FIG. 22(a) is configured to manufacture two anodes 8. The electrode body 5 for batteries includes the first structural member 2a of an H shape, the second structural member 2b of an H shape, the first metal portion 1a and the second metal portion 1b which are provided to be interposed between the extending portions of the first structural member 2a, a third metal portion 1c and a fourth metal portion 1d which are provided to be interposed between the extending portions of the second structural member 2b, the first cover member 21a which is provided to be interposed between the second metal portion 1b and the third metal portion 1c, the second cover member 21b which covers the side surface of the first metal portion 1a, and a third cover member 21c which covers the side surface of the fourth metal portion 1d.

With such a configuration, two anodes 8 can be manufactured from one electrode body 5 for batteries, and the electrode active material can be effectively stored and transported.

The electrode body 5 for batteries illustrated in FIG. 22(b) is configured to manufacture three anodes 8. The electrode body 5 for batteries includes the first structural member 2a of a box shape, the second structural member 2b of a box shape, a third structural member 2i of an H shape, the first metal portion 1a which is contained in the first structural member 2a of the box shape, the second metal portion 1b which is contained in the second structural member 2b of the box shape, the third metal portion 1c and the fourth metal portion 1d which are provided to be interposed between the extending portions of the third structural member 2i, the first cover member 21a which is provided to be interposed between the first metal portion 1a and the third metal portion 1c, and the second cover member 21b which is provided to be interposed between the second metal portion 1b and the fourth metal portion 1d.

With such a configuration, three anodes 8 can be manufactured from one electrode body 5 for batteries, and the electrode active material can be effectively stored and transported.

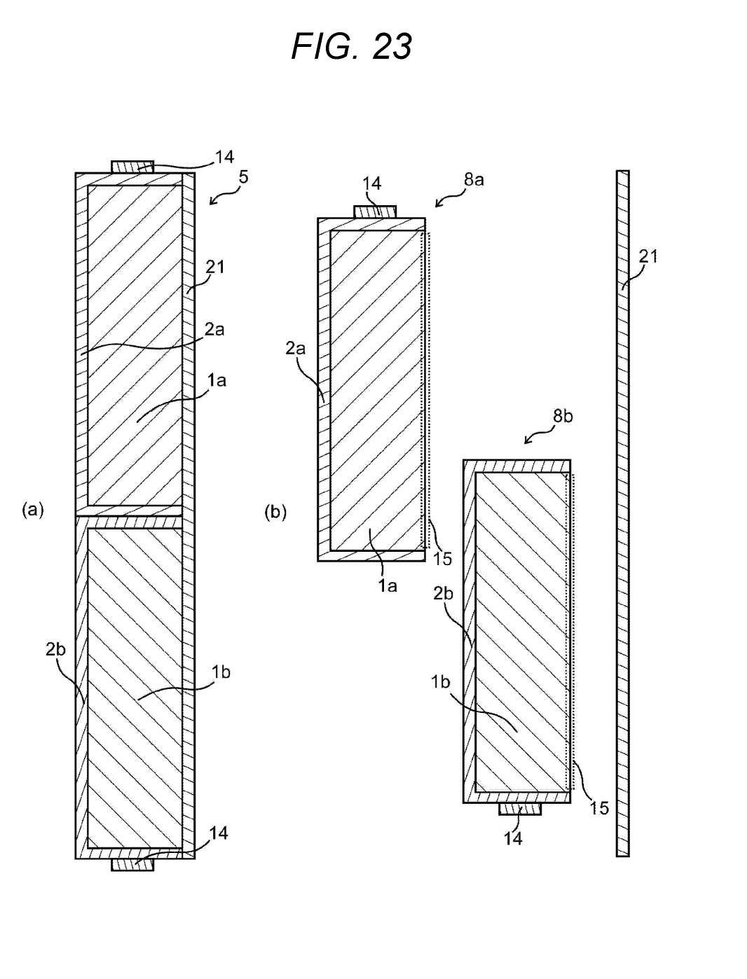

FIG. 23(a) is a schematic cross-sectional view of the electrode body 5 for batteries, and FIG. 23(b) is a schematic cross-sectional view of the anodes 8a and 8b manufactured from the electrode body 5 for batteries of FIG. 23(a). The electrode body 5 for batteries includes the first structural member 2a of box shape, the second structural member 2b of a box shape, the first metal portion 1a which is contained in the first structural member 2a of the box shape, the second metal portion 1b which is contained in the second structural member 2b of the box shape, and the cover member 21 which closes both the opening of the first structural member 2a and the opening of the second structural member 2b by one main surface.

With such a configuration, two anodes 8 can be manufactured from one electrode body 5 for batteries, and the electrode active material can be effectively stored and transported. In addition, since the opening of the first structural member 2a and the opening of the second structural member 2b both can be closed by one cover member 21, the number of components can be reduced.

Metal Air Battery

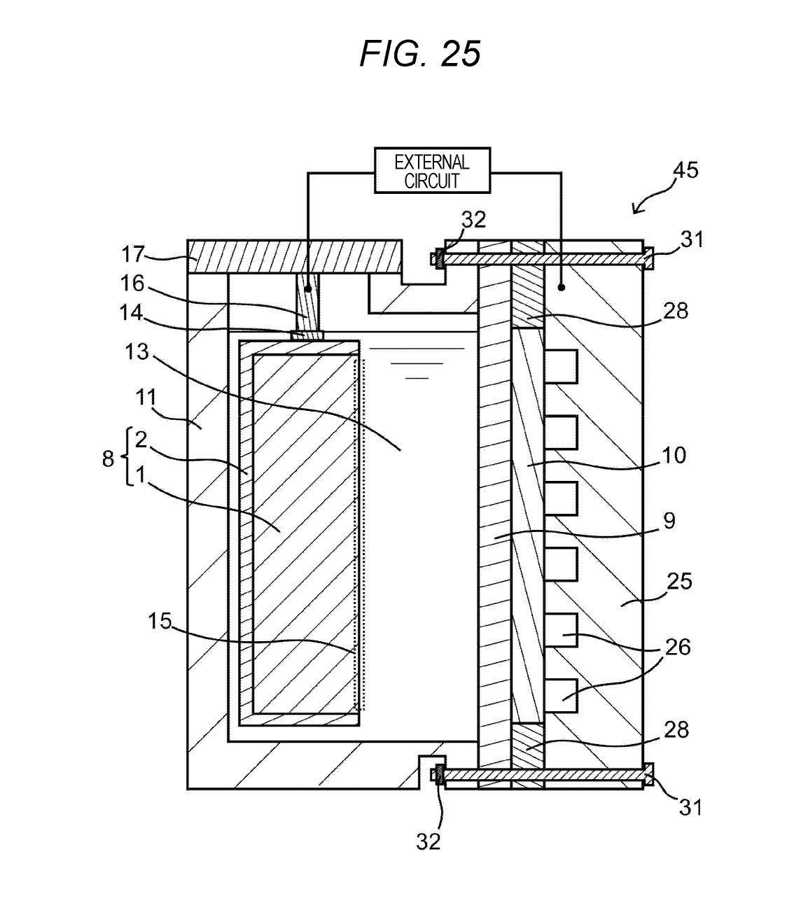

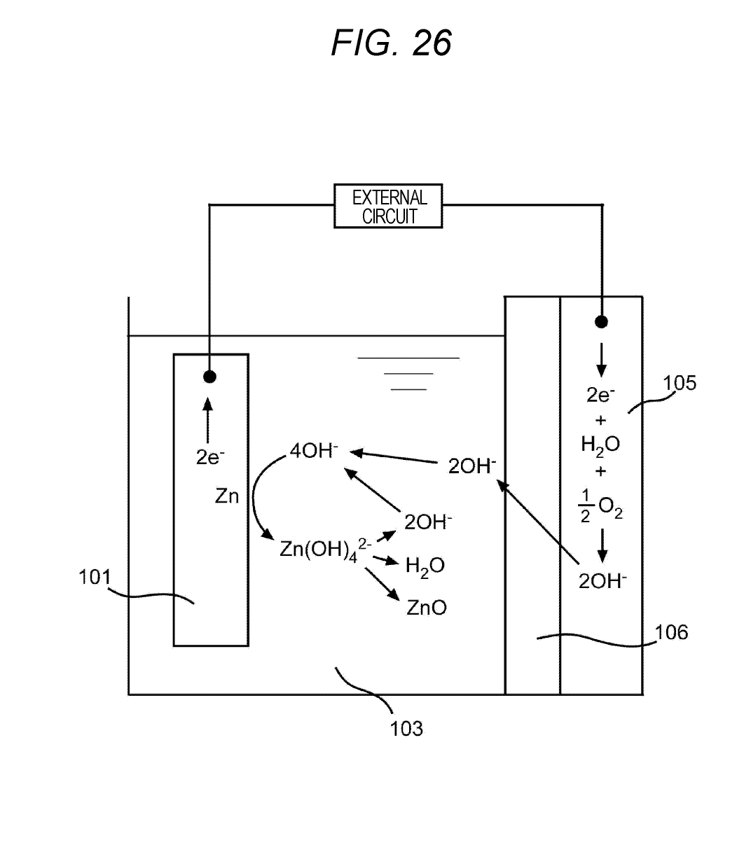

FIGS. 9 and 25 are schematic cross-sectional views of the metal air battery 45 of this embodiment. Further, the metal air battery 45 illustrated in FIG. 9 is the metal air battery 45 to which the anode 8 of the first embodiment is assembled, and the metal air battery 45 illustrated in FIG. 25 is the metal air battery 45 to which the anode 8 of the second embodiment is assembled.

The metal air battery 45 of this embodiment includes the anode 8 of the first embodiment or the second embodiment, the liquid electrolyte tank 11 which stores a liquid electrolyte 13, and an air electrode 10 which serves as a cathode. The anode 8 is provided to be inserted into the liquid electrolyte tank 11 and inserted into the inside of the liquid electrolyte tank 11.

In addition, the metal air battery 45 of this embodiment may further include an ion-exchange film 9 which is provided between the anode 8 and the air electrode 10. The ion-exchange film 9 may be provided such that the first main surface comes in contact with the liquid electrolyte stored in the liquid electrolyte tank 11 and the second main surface comes in contact with the air electrode 10.

1. Metal Air Battery

The metal air battery 45 of this embodiment, for example, includes a zinc air battery, a lithium air battery, a sodium air battery, a calcium air battery, a magnesium air battery, an aluminum air battery, an iron air battery, and the like. In addition, the metal air battery 45 of this embodiment may be a primary battery, or may be a secondary battery. In this case, the primary battery is desirable. In a case where the metal air battery 45 of this embodiment is the primary battery, the electrode active material can be supplied to the metal air battery 45 by assembling the anode 8 of this embodiment to the main body of the metal air battery.

2. Liquid Electrolyte Tank and Liquid Electrolyte

The liquid electrolyte tank 11 is an electrolyte tank which stores the liquid electrolyte 13, and made of a material having corrosion resistance against the liquid electrolyte. In addition, the liquid electrolyte tank 11 is configured to dispose the anode 8 therein. In addition, the liquid electrolyte tank 11 is configured such that ions included in the stored liquid electrolyte 13 migrate to the air electrode 10. Therefore, the ions can be conducted between the anode 8 and the air electrode 10 through the liquid electrolyte 13 stored in the liquid electrolyte tank 11.

The liquid electrolyte 13 is an ion conductive liquid obtained by dissolving electrolyte into a solvent. The type of the liquid electrolyte 13 is different according to the metal of the electrode active material portion 3 or the metal portion 1, the liquid electrolyte (electrolytic aqueous solution) using an aqueous solvent may be employed, or the liquid electrolyte (organic liquid electrolyte) using an organic solvent may be employed.

For example, in the case of the zinc air battery, the aluminum air battery, and the iron air battery, an alkaline aqueous solution such as an aqueous sodium aqueous solution or an aqueous calcium aqueous solution can be employed in the liquid electrolyte. In the case of a magnesium air battery, a sodium chloride aqueous solution can be employed in the liquid electrolyte. In addition, in the case of the lithium air battery, the sodium air battery, and the calcium air battery, the organic liquid electrolyte can be employed.

In addition, the liquid electrolyte tank 11 may include a partition wall made of a solid electrolyte and be partitioned by the partition wall, and store an electrolytic aqueous solution on a side of the partitioned space and the organic liquid electrolyte on the other side.

3. Anode

As described above, the anode 8 can be obtained from the electrode body 5 for batteries of the first embodiment or the second embodiment, and includes the electrode active material portion 3 or the metal portion 1 and the structural member 2. The electrode active material portion 3 or the metal portion 1 includes the metal as the electrode active material as the main component, and at least a part of the structural member 2 serves as the collector.

Further, FIG. 25 illustrates the metal air battery 45 in which the anode 8 illustrated in FIGS. 11(b), 20(b), 21(b), and 23(b) is assembled to the main body of the metal air battery, but the anode 8 assembled to the main body of the metal air battery may be the anode 8 illustrated in FIGS. 12(b), 13(b), 14(b), 15(b), 16(b), 18(b), and 19(b).

The electrode active material portion 3 or the metal portion 1, for example, is made of zinc metal in the case of the zinc air battery, aluminum metal in the case of an aluminum air battery, iron metal in the case of an iron air battery, and magnesium metal in the case of a magnesium air battery.

In addition, in the case of a lithium air battery, a sodium air battery, or a calcium air battery, the electrode active material portion 3 or the metal portion 1 is made of lithium metal, sodium metal, or calcium metal.

In addition, the description has been made about that the electrode active material portion 3 or the metal portion 1 is made of a type of metal in the above-mentioned example, but the electrode active material portion 3 or the metal portion 1 may be an alloy or may include an inorganic material or an organic material.

The anode 8 is provided to be inserted into the liquid electrolyte tank 11, and can be inserted into the inside of the liquid electrolyte tank 11. For example, when the power is generated by the metal air battery 45 illustrated in FIG. 9 or 25, the metal of the electrode active material portion 3 or the metal portion 1 is consumed by the battery reaction. When the metal is consumed, the anode 8 is inserted into the inside of the liquid electrolyte tank 11 together with a cover member 17 and the supporting member 16. Thereafter, the supporting member 16 connected to the cover member 17 is connected to the connection terminal 14 of a new anode 8 formed from the electrode body 5 for batteries, and the new anode 8 is inserted into the liquid electrolyte tank 11.

In this way, the anode 8 from which the electrode active material is consumed is inserted into the inside of the liquid electrolyte tank 11, and the new anode 8 is inserted into the liquid electrolyte tank 11, so that the electrode active material can be supplied to the metal air battery 45.

In the new anode 8 inserted into the liquid electrolyte tank 11, the oxide film is not formed in the division surface 12 or the metal exposing surface 15, so that the electrode reaction can be progressed in the division surface 12 or the metal exposing surface 15 immediately after the anode 8 is inserted. Therefore, it is possible to improve the initial characteristic of the metal air battery 45. In addition, when the new anode 8 is inserted into the liquid electrolyte tank 11, the division surface 12 or the metal exposing surface 15 can be inserted to face the air electrode 10. Therefore, it is possible to shorten a distance between the division surface 12 or the metal exposing surface 15 where the electrode reaction of the anode is progressed and the air electrode 10 where the electrode reaction of the cathode is progressed. Further, it is possible to increase the efficiency in power generation.

The structural member 2 included in the anode 8 serves as the collector. In a case where the structural member 2 is made of the conductive material such as a metal plate, the electrode active material portion 3 or the metal portion 1 can be electrically connected to an external circuit through the structural member 2 and the supporting member 16. Therefore, the metal air battery 45 can output the power.

In a case where the anode 8 is formed from the electrode body 5 for batteries as illustrated in FIG. 3(a) or a case where the anode 8 is used as illustrated in FIG. 13(b), the collector portion 6 in the side portion and the upper portion of the anode 8 serves as the collector. In addition, the insulation portion 7 of the lower portion of the anode 8 insulates the bottom of the liquid electrolyte tank 11 from the anode 8, and suppresses the flow of the short-circuit current.

In a case where the anode 8 is formed from the electrode body 5 for batteries as illustrated in FIG. 3(b) or a case where the anode 8 is used as illustrated in FIG. 14(b), the collector portion 6 of the side portion of the anode 8 serves as the collector. In addition, the insulation portion 7 of the lower portion and the upper portion of the anode 8 insulates the bottom and the upper portion of the liquid electrolyte tank 11 from the anode 8, and suppresses the flow of the short-circuit current.

In a case where the anode 8 is formed from the electrode body 5 for batteries as illustrated in FIG. 3(c) or a case where the anode 8 is used as illustrated in FIG. 15(b), the collector portion 6 provided to come in contact with the side surface of the electrode active material portion 3 or the metal portion 1 serves as the collector. The insulation portion 7 provided in the lower portion and the upper portion of the anode 8 and the insulation portion 7 provided on the outside of the collector portion 6 insulate the liquid electrolyte tank 11 from the anode 8, and suppress the flow of the short-circuit current.

In addition, the structural member 2 is provided in the lower portion of the anode 8, so that it is possible to suppress that the metal of the electrode active material portion 3 or the metal portion 1 is consumed as the electrode reaction is progressed and a large ingot of the metal peels off from the anode 8.

Further, the description herein has been made using the metal air battery 45 to which the anode 8 illustrated on the right side of FIG. 5 or the anode 8 illustrated in FIG. 11(b) is assembled. However, as illustrated on the right side of FIG. 6 or the right side of FIG. 7, the anode 8 assembled to the metal air battery 45 may be configured such that the anode 8 obtained by bonding two divided electrode bodies for batteries is assembled to the metal air battery 45. Further, as illustrated on the right side of FIG. 8, the anode 8 obtained by bonding four divided electrode bodies for batteries may be assembled to the metal air battery 45. In addition, the anode 8 assembled to the metal air battery 45 may be obtained by bonding six, eight, or ten divided electrode bodies for batteries.

4. Air Electrode and Ion-Exchange Film

The air electrode 10 is an electrode which generates hydroxide ions (OH—) from oxygen gas and water in the air and electrons. The air electrode 10, for example, is formed by a conductive porous carrier and an air electrode catalyst which is carried in the porous carrier. Therefore, the oxygen gas, the water, and the electrons can exist together in the air electrode catalyst, and the electrode reaction can be progressed. The water used in the electrode reaction may be supplied from the air, or may be supplied from the liquid electrolyte.

As the porous carrier, for example, carbon black such as acetylene black, furnace black, channel black, or Ketjen black, and conductive carbon particles such as black lead or activated carbon are exemplified. In addition, a carbon fiber such as a vapor grown carbon fiber (VGCF), a carbon nanotube, or a carbon nanowire may be used.

As the air electrode catalyst, platinum, iron, cobalt, nickel, palladium, silver, ruthenium, iridium, molybdenum, manganese, a metal compound thereof, and fine particles made of an alloy including two or more types of the above metals are exemplified. It is desirable that the alloy include at least two or more types of metals among platinum, iron, cobalt, and nickel. For example, a platinum-iron alloy, a platinum-cobalt alloy, an iron-cobalt alloy, a cobalt-nickel alloy, an iron-nickel alloy, and an iron-cobalt-nickel alloy are exemplified.

In addition, the porous carrier included in the air electrode 10 may be subjected to surface treatment such that a cation group exists as fixed ions in the surface. Therefore, the hydroxide ions can be conducted through the surface of the porous carrier, so that the hydroxide ions generated on the air electrode catalyst easily migrate.

In addition, the air electrode 10 may have an anion exchange resin carried in the porous carrier. Therefore, the hydroxide ions can be conducted through the anion exchange resin, so that the hydroxide ions generated on the air electrode catalyst easily migrate.

The air electrode 10 may be provided to come in direct contact with the air, or may be provided to come in contact with an air flow pas sage 26. Therefore, the oxygen gas can be supplied to the air electrode 10. In addition, in a case where the air flow passage 26 is provided, the water together with the oxygen gas can also be supplied to the air electrode 10 by making a humidified air flow through the air flow passage 26. The air flow passage 26, for example, can be provided in a collector member 25 included in the metal air battery 45 illustrated in FIG. 9 or 25. Therefore, the air flow passage 26 can be formed and the air electrode 10 can be connected to the external circuit through the collector member 25, and the power of the metal air battery 45 can be output to the external circuit.

The air electrode 10 may be provided to come in contact with the liquid electrolyte 13 stored in the liquid electrolyte tank 11. Therefore, the hydroxide ions generated by the air electrode 10 can easily migrate to the liquid electrolyte 13. In addition, the water necessary for the electrode reaction in the air electrode 10 is easily supplied from the liquid electrolyte 13 to the air electrode 10.

In addition, the air electrode 10 may be provided to come in contact with the ion-exchange film 9 which comes in contact with the liquid electrolyte 13 stored in the liquid electrolyte tank 11. The ion-exchange film 9 may be an anion exchange film. Therefore, the hydroxide ions generated by the air electrode 10 is conducted through the anion exchange film, and can migrate to the liquid electrolyte.

With the configuration of the ion-exchange film 9, it is possible to restrict the type of ions migrating between the air electrode 10 and the liquid electrolyte 13. In a case where the ion-exchange film 9 is the anion exchange film, the anion exchange film has the cation group which is the fixed ions, so that the cations in the liquid electrolyte are not allowed to be conducted to the air electrode 10. On the contrary, the hydroxide ions generated by the air electrode 10 are anions, so that the hydroxide ions can be conducted to the liquid electrolyte. Therefore, the battery reaction of the metal air battery 45 can be progressed, and it is possible to prevent that the cations in the liquid electrolyte 13 migrate to the air electrode 10. Accordingly, it is possible to suppress that the metal or the carbonate compound in the air electrode 10 is precipitated.

In addition, with the configuration of the ion-exchange film 9, it is possible to suppress that the water included in the liquid electrolyte is excessively supplied to the air electrode 10.

As the ion-exchange film 9, for example, a solid polyelectrolyte film (the anion exchange film) of a perfluorosulfonic acid system, a perfluorocarboxylic acid system, a styrene vinyl benzene system, and a quaternary ammonium system is exemplified.

In a case where the air electrode 10 is provided to come in contact with the ion-exchange film 9, for example, the air electrode 10 may be formed on the ion-exchange film 9, and interposed between the liquid electrolyte tank 11 and the collector member 25 as illustrated in FIG. 9.

### REFERENCE SIGNS LIST

1, 1a, 1b, 1c, 1d: Metal portion
2: Structural member
2a, 2c, 2e, 2g: First structural member
2b, 2d, 2f, 2h: Second structural member
2i: Third structural member
3: Electrode active material portion
3a, 3c, 3e, 3g: First electrode active material portion
3b, 3d, 3f, 3h: Second electrode active material portion
4: Film portion
5, 5a, 5b, 5c, 5d: Electrode body for batteries
6: Collector portion
6a: First collector portion
6b: Second collector portion
7: Insulation portion
7a: First insulation portion
7b: Second insulation portion
8: Anode
8a: First anode
8b: Second anode
9: Ion-exchange film
10: Air electrode
11: Liquid electrolyte tank
12: Division surface
12a: First division surface
12b: Second division surface
13: Liquid electrolyte
14: Connection terminal
15: Metal exposing surface
16: Supporting member
17: Cover member
18: First main surface
19: Second main surface
21: Cover member
21a: First cover member
21b: Second cover member
21c: Third cover member
25: Collector member
26: Air flow passage
28: Spacer
31: Bolt
32: Nut
45: Metal air battery
101: Zinc electrode
103: Alkaline liquid electrolyte
105: Air electrode
106: Anion exchange film

1-24. (canceled)

25: An electrode body comprising:
a first metal portion configured to include metal as an electrode active material as a main component;
a first structural member configured to cover a part of the surface of the first metal portion; and
a coating member configured to cover the other part of the surface of the first metal portion or a part of the surface of the first structural member,
wherein the surface of the first metal portion is covered by the first structural member and/or the coating member, and
the coating member is provided to be separated from the first metal portion and/or the first structural member.

26: The electrode body according to claim 25,
wherein the coating member is a second structural member,
the first metal portion includes first and second electrode active material portions,
the first structural member is provided to be disposed on a first electrode active material portion, and
the second structural member is provided to be disposed on a second electrode active material portion.

27: The electrode body according to claim 26,
wherein the first and second structural members cover the entire surface of the first metal portion.

28: The electrode body according to claim 25,
wherein the first metal portion includes a film portion where first and second main surfaces cover the metal, and is provided to be divided into first and second electrode active material portions by peeling the film portion from the metal.

29: The electrode body according to claim 25,
wherein the coating member is a cover member, and
the cover member is provided to be separated from the first metal portion to expose the metal of the surface of the first metal portion serving as an electrode surface.

30: The electrode body according to claim 29,
wherein the first structural member and the cover member both cover the entire surface of the first metal portion.

31: The electrode body according to claim 29, further comprising:
a second metal portion configured to include metal as an electrode active material as a main component,
wherein the first structural member has two main surfaces in which one main surface covers a part of the surface of the first metal portion and the other main surface covers a part of the surface of the second metal portion, and
the cover member is provided to cover the surface of the second metal portion serving as an electrode surface, and to be separated from the second metal portion to expose the metal of the surface of the second metal portion.

32: The electrode body according to claim 31,
wherein the first structural member and the cover member both cover the entire surface of the second metal portion.

33: The electrode body according to claim 29, further comprising:
a second metal portion configured to include metal as an electrode active material as a main component; and
a third structural member configured to come in contact with a part of the surface of the second metal portion,
wherein the cover member is provided to come in contact with the surface of the second metal portion serving as an electrode surface, and to be separated from the second metal portion to expose the metal of the surface of the second metal portion.

34: The electrode body according to claim 33,
wherein the third structural member and the cover member both cover the entire surface of the second metal portion.

35: The electrode body according to claim 29, further comprising:
a second metal portion configured to include metal as an electrode active metal as a main component; and
a third structural member configured to come in contact with a part of the surface of the second metal portion,
wherein the first structural member is provided to come in contact with the surface of the second metal portion serving as an electrode surface, and to be separated from the second metal portion to expose the metal of the surface of the second metal portion.

36: The electrode body according to claim 35,
wherein the first and third structural members both cover the entire surface of the second metal portion.

37: The electrode body according to claim 25,
wherein the first structural member is made of a conductive material.

38: The electrode body according to claim 25,
wherein the first structural member includes a conductive collector portion which comes in contact with the surface of the first metal portion and an insulative insulation portion.

39: The electrode body according to claim 38,
wherein the insulation portion is provided on the outside of the collector portion.

40: The electrode body according to claim 25,
wherein the first structural member includes a connection terminal.

41: The electrode body according to claim 25,
wherein the metal is any one of zinc metal, calcium metal, magnesium metal, aluminum metal, iron metal, lithium metal, and sodium metal.

42: A metal air battery comprising:
a liquid electrolyte tank configured to contain a liquid electrolyte and to include an air electrode serving as a cathode; and
an electrode body configured to serve as an anode which is provided to be inserted into the liquid electrolyte tank,
wherein the electrode body includes
a first metal portion which includes metal as an electrode active material as a main component, and
a first structure member which covers a part of the surface of the first metal portion, and
the electrode body further includes a coating member which covers the other part of the surface of the first metal portion or a part of the first structural member.

43: The metal air battery according to claim 42,
wherein the coating member is a second structural member, and
the electrode body includes a contact surface in which the edge of the first structural member and the edge of the second structural member come in contact with each other.

44: The metal air battery according to claim 42,
wherein the metal portion includes two or more electrode active material portions, and
film members are provided in the surfaces of one or more electrode active material portions.
